(19) United States
(12) Patent Application Publication
(10) Pub. No.: US 2024/0262620 A1
(43) Pub. Date: Aug. 8, 2024

(54) STORAGE AND RETRIEVAL SYSTEM AND STACK PROCESSING APPARATUS

(71) Applicant: Ocado Innovation Limited, Hatfield, Hertfordshier (GB)

(72) Inventor: Andrew INGRAM-TEDD, Hatfield, Hertfordshire (GB)

(73) Assignee: Ocado Innovation Limited, Hatfield, Hertfordshire (GB)

(21) Appl. No.: 18/565,753

(22) PCT Filed: Jun. 1, 2022
(86) PCT No.: PCT/EP2022/064978

§ 371 Date: Nov. 30, 2023

(30) Foreign Application Priority Data
Jun. 2, 2021 (GB) 2107911.6
Nov. 19, 2021 (GB) 2116750.7
Dec. 20, 2021 (GB) 2118494.0

(51) Int. Cl. B65G 1/04; B65G 1/137; B65G 60/00

(52) U.S. Cl. CPC B65G 1/0492; B65G 1/0464; B65G 1/0471; B65G 1/1378; B65G 60/00; B65G 2201/0235

(57) ABSTRACT

A storage and retrieval system in which items are stored in containers. The containers are arranged in stack units. Each stack unit includes a stand including a stand top and one or more legs extending downwardly from the stand top. The containers are arranged in a stack on top of the stand top. Each stack unit is movable by a vehicle dimensioned to allow the vehicle to move underneath the stand top. Each vehicle includes a lifting mechanism moveable between a raised position and a lowered position to raise the stack unit off the ground and lower the stack unit onto the ground respectively.

### TECHNICAL FIELD

The present invention relates to a storage and retrieval system in which items are stored in stacks of storage containers. The present invention also relates to an apparatus for processing stacks of containers. In particular, the present invention relates to an apparatus for extracting containers from and inserting containers into a vertical stack of containers.

### BACKGROUND

Some commercial and industrial activities require systems that enable the storage and retrieval of a large number of different products. WO2015/185628A describes a storage and retrieval system in which stacks of containers are arranged within a grid storage structure. The containers are accessed from above by load handling devices operative on rails or tracks located on the top of the grid framework structure. When a product is required, the container containing the item is lifted out of the grid storage structure by a load handling device and transported to a picking station where the item can be picked from the container before sending the container back to the grid storage structure.

Systems such as the one described in WO2015/185628A can require a large amount of space to house the grid storage structure as well as high capital and time costs to build. It is desirable to provide a storage and retrieval system that has reduced space, capital and building time requirements.

### SUMMARY OF INVENTION

The invention is defined in the accompanying claims.

### Storage and Retrieval System

A storage and retrieval system is provided, comprising:
one or more stack units, each stack unit comprising:
   a stand comprising a stand top and one or more legs extending downwardly from the stand top; and
   one or more containers located on the stand top; and
one or more vehicles dimensioned to allow the vehicle to move underneath the stand top, each vehicle comprising a lifting mechanism moveable between a raised position and a lowered position to raise the stack unit off the ground and lower the stack unit onto the ground respectively.

By providing an intermediate stand between the containers (or any other object) and the vehicle, the vehicle can quickly and efficiently lift and move the containers without having to wait for the containers to be directly loaded onto the vehicle. Furthermore, once the vehicle has deposited the stack unit at a desired location, the vehicle is immediately free to go to a different location (e.g. to move another stack unit) without having to wait for the containers to be unloaded from the vehicle. Furthermore, a plurality of stack units can be centrally stored without the need for any storage structure other than a floor area large enough to store them, thereby reducing capital and building time costs compared to the grid storage structures mentioned in the background section.

When a plurality of containers are located on the stand top, the containers may be directly stacked on top of each other to form a vertical stack. The containers may be reversibly stacked, i.e. they can be readily stacked and unstacked. The stack may comprise containers of different heights. The stack may be directly located on the stand top.

Arranging containers into vertical stacks is an efficient way of densely storing items. Storing items in stackable containers also aids automation compared to fixed storage means such as shelving because items can be reorganised by changing the arrangement of the containers within a stack or moving containers between different stacks, which may be easier than directly reorganising the items themselves. Furthermore, by forming or placing each stack on top of a stand that can accommodate a lifting vehicle below it, whole stacks can be conveniently and efficiently transported and re-located around a facility by simply lifting the stand with the desired stack on top of it.

Each container may comprise one or more interlocking features configured to reversibly interlock with one or more corresponding interlocking features of adjacent containers in the vertical stack. For example, the top of each container may comprise one or recesses and the bottom of each container may comprise one or more corresponding protrusions, or vice versa. The interlocking features help the stack of containers to remain stable, particularly during when the stack unit is lifted and transported by the vehicle.

Each container may be removably receivable on the stand top, i.e. not fixed to the stand top. Each container may comprise one or more interlocking features configured to reversibly interlock with one or more corresponding interlocking features on the stand top. For example, the bottom of each container may comprise one or more protrusions and the top of the stand top may comprise one or more corresponding recesses. The interlocking features for allowing the containers to interlock with each other may be the same as the interlocking features for allowing each container to interlock with the stand, or they may be different. The interlocking features for interlocking the containers and the stand help the stack of containers to remain stable on the stand, particularly when the stack unit is lifted and transported by the vehicle.

The stand top may comprise one or more locating features configured to cooperate with one or more corresponding locating features on the one or more containers to help locate a container into a particular position on the stand top. The locating features and corresponding locating features may comprise tapered edges, for example, and may be located on the top of the stand top and on the bottom of each container. The locating features of each container may also cooperate with corresponding locating features on each container to help to locate containers on top of each other when forming a vertical stack of containers.

Each container may be an open-topped container (i.e. comprising an opening at the top of the container). This allows items to be easily placed into and taken out of the containers and aids automation of these tasks (e.g. by allowing a camera to view the contents of the container and allow a robotic arm to access the items in the container). The footprint of each container may be substantially the same as the footprint of the stand (i.e. the base of each container may be substantially the same size as the stand top) to improve stability and maximise the use of space available to store the stack units.

Each vehicle may be an automated or autonomous vehicle, e.g. an automated guided vehicle (AGV) which is capable of following fixed routes, or an autonomous mobile robot (AMR) which is capable of planning its own routes. This allows the transport of the stack units to be automated, which increases the efficiency of the storage and retrieval system even further. Each vehicle may comprise a driving mechanism configured to allow the vehicle to move in a plurality of directions. For example, the driving mechanism may be configured to allow the vehicle to move forwards and backwards in at least two orthogonal directions. The driving mechanism may allow the vehicle to rotate about a vertical axis to allow the vehicle to change direction. The storage and retrieval system may comprise a control system configured to direct the one or more vehicles to lift and move the stack units to particular locations in the storage and retrieval system.

When the lifting mechanism is in the raised position, the total height of the vehicle may be greater than the height of the stand top above the ground so that the stack unit is lifted off the ground by the vehicle. When the lifting mechanism is in the lowered position, the total height of the vehicle may be less than the height of the stand top above the ground so that the stack unit can rest on the ground with the vehicle underneath it.

The lifting mechanism may comprise a lifting surface moveable relative to the rest of the vehicle between the raised position and the lowered position. The lifting surface may engage the stand top (e.g. the bottom of the stand top) when the lifting surface is in the raised position and disengage from the stand top when the lifting surface is in the lowered position. The lifting surface (e.g. the top of the lifting surface) may comprise one or more interlocking features (e.g. protrusions or recesses) configured to reversibly interlock with one or more corresponding interlocking features on the stand top (e.g. the bottom of the stand top). The interlocking features on the vehicle and the stand top help the stack unit to remain stable on the vehicle when being lifted and transported. The lifting mechanism may comprise a linear actuator for raising and lowering the lifting surface. The linear actuator may be any suitable type of actuator, e.g. pneumatic, hydraulic, electric, etc. The lifting surface and the rest of the vehicle may rotate relative to each other about a vertical axis such that the vehicle can change direction on the spot without moving the stack unit on top of the lifting surface.

The stand top and the one or more legs may define a space underneath the stand top and one or more side openings for allowing the vehicle to enter and exit the space. The one or more side openings may be defined between adjacent legs. A side opening may be defined on more than one side of the stand to allow the vehicle to enter and exit the space from more than one direction. A pair of opposing side openings may be defined. Two pairs of opposing side openings may be defined, with one pair being orientated orthogonal to the other pair. The stand top may have a rectangular shape with four legs extending downwardly from the four corners of the stand top. A side opening may be defined on each side of the stand, between each pair of adjacent legs. This may allow a vehicle to enter and exit the space underneath the stand top regardless of the orientation of the stack unit. Furthermore, if the stack units are arranged in a grid pattern such that the side openings of adjacent stack units are aligned, then a vehicle can efficiently travel from one side of the grid pattern to another side by travelling “through” the grid pattern, rather than having to travel around the outside of the grid pattern. This also allows the stack units to be more densely arranged because no or fewer access aisles for the vehicles are required between the stack units.

Each vehicle may be dimensioned such that each vehicle can completely fit in the space underneath the stand top in the vertical direction. In other words, the greatest vertical dimension of each vehicle is smaller than the smallest vertical dimension of the space underneath the stand top.

The horizontal footprint of each vehicle may be substantially similar to or smaller than the horizontal footprint of each stack unit. Each vehicle may be dimensioned such that the lateral outer perimeter of each vehicle can be fully contained within the space defined underneath the stand top (i.e. the vehicle does not extend laterally beyond the stand top). This allows the vehicle to move and place stack units close to other stack units or other objects or walls, which improves storage density. Access routes for the vehicle can also be made smaller, so that the storage and retrieval system requires less overall space.

The bottom of each leg may comprise a wheel (e.g. a caster wheel) to allow the stack units to be pushed around when not being lifted by a vehicle. This may be useful, for example, for pushing the stack units up or down ramps (e.g. onto a lorry) which may not be suitable for the vehicle when lifting a stack unit.

The storage and retrieval system may comprise a plurality of stack units arranged in a grid pattern (i.e. the stack units are arranged in a regular pattern along two orthogonal directions), which allows for a dense and space-efficient arrangement.

The storage and retrieval system may comprise a storage area for storing the one or more stack units. The stack units may be arranged in a grid pattern within the storage area.

The storage and retrieval system may further comprise a picking station at which items are picked from one or more containers of a stack unit. At the picking station, a target container may be extracted from a stack unit so that an item can be picked out of the target container. After picking, the container may be returned to the same or a different stack unit, which may then be returned to the storage area.

The storage and retrieval system may further comprise a filling station at which empty or partially full containers are filled with items and arranged to form new stack units or transferred onto existing stack units. The new or updated stack units may then be transported to the storage area.

The storage and retrieval system may comprise a control system communicably coupled to the one or more vehicles. The control system may be configured to control movement of the one or more vehicles to transport the one of more stack units between the storage area, the picking station and the filling station. For example, newly formed or updated stack units may be moved from the filling station to the storage area. When an item from a container in a stack unit needs to be retrieved, the stack unit may be moved from the storage area to the picking station. The stack unit may then be returned to the storage area until an item is need again. Alternatively, if a container needs to be replenished or the stack unit needs to receive a new container, the stack unit may be moved from the picking station to the filling station.

The storage area may comprise a containing lifting device arranged above the stack units in the storage area. The containing lifting device may be configured to transfer a container from the top of one of the stack units to the top of another stack unit. The container lifting device may comprise a container grabber configured to releasably engage a container at the top of a stack unit. The container grabber may be further configured to move in the vertical direction to raise and lower the container. The container grabber may be further movable in a horizontal direction to transfer the container onto another stack unit.

The filling station and/or the picking station may comprise one or more stack processing apparatuses as defined below.

### Stack Processing Apparatus

A stack processing apparatus for moving a container out of and/or into a vertical stack of containers is provided. The stack processing apparatus comprises:
a stack receiving region for receiving a vertical stack of containers;
a stack separating mechanism comprising a separating member configured to releasably engage a container in the stack, the separating member being vertically moveable within the stack receiving region to allow the separating member to engage any container in the stack and vertically lift the engaged container to separate the stack into an upper sub-stack and a lower sub-stack to expose a target container at the top of the lower sub-stack; and
a container handling mechanism comprising a handling member configured to releasably engage the target container in the stack, the handling member being vertically moveable with respect to the stack receiving region and horizontally moveable to allow the handling member to engage and horizontally extract the target container out of the stack, and/or functioning in a reverse manner to insert a free container into the stack.

The stack processing apparatus thus allows efficient and direct access to any container within a stack and/or efficient and direct insertion of a container into any position within a stack. These tasks can also be performed even if the containers within a stack have different height dimensions. The stack processing apparatus may be useful in a storage and retrieval system in which items are stored in containers arranged in vertical stacks and direct access to individual containers within a stack allows items to be retrieved in an efficient and timely manner.

At least a portion of the handling member may be linearly moveable in a horizontal direction towards and away from the stack receiving region. For example, the handling member may comprise a retractable arm configured to linearly extend and retract in a horizontal direction towards and away from the stack receiving region.

At least a portion of the handling member may be pivotally mounted for movement in a horizontal direction towards and away from the stack receiving region.

At least a portion of the separating member and/or at least a portion of the handling member may be moveable towards and away from the stack to engage and release a container in the stack respectively. The separating member and/or handling member may comprise engaging features for engaging corresponding features on a container. The engaging features may be, for example, protrusions, recesses, apertures, etc.

The stack separating mechanism may comprise a pair of horizontally opposed separating members configured to engage a container therebetween and/or the container handling mechanism may comprise a pair of horizontally opposed handling members configured to engage a container therebetween.

The stack processing apparatus may further comprise a container receiving region horizontally adjacent to the stack receiving region. The handling member may be vertically movable within the container receiving region and horizontally moveable between the container receiving region and the stack receiving region to extract the target container from the stack into the container receiving region and/or insert a free container from the container receiving region into the stack.

The stack processing apparatus may further comprise a container port region horizontally adjacent to the container receiving region. The container port region may comprise a container port configured to receive a target container from the container receiving region and/or receive a free container to be moved into the container receiving region.

The container port region may comprise a plurality of container ports arranged vertically. For example, the container ports may be arranged directly above or below each other, or they may be horizontally offset from each other at different vertical levels. Alternatively, the container ports may be arranged in a horizontal plane about the container receiving region (at the same vertical level).

The handling member may be horizontally movable between the container receiving region and the container port region to allow the handling member to move the target container from the container receiving region to one or more of the container ports and/or to move a free container from one or more of the container ports to the container receiving region.

The container handling mechanism may comprise a plurality of vertically arranged handling members. Each handling member may be vertically moveable within the container receiving region independently of the other handling members. At least one handling member of the plurality of handling members may be horizontally moveable between the container receiving region and the container port region.

At least one of the container ports may be an out-feed port configured to receive the target container from the container receiving region and at least one of the container ports may be an in-feed port configured to receive a free container to be moved to the container receiving region.

The out-feed port may be connected to the in-feed port by a container path external to the container receiving region, along which the target container can travel from the out-feed port to the in-feed port. The container path may be configured to automatically convey the container from the out-feed port to the in-feed port. For example, the container path may be in the form of a conveyor. The container path may be continuous between the out-feed port and the in-feed port to allow a container to travel between the out-feed port and the in-feed port uninterrupted (though the container path may be configured to stop a container at one or more locations along the container path as required).

The out-feed port and the in-feed port may be vertically arranged. For example, the out-feed port may be arranged below the in-feed port or vice versa. The container path may comprise vertical transportation means configured to move a container from the height of the out-feed port to the height of the in-feed port, optionally via one or more intermediate heights between out-feed port and the in-feed port. The vertical transportation means may, for example, be an inclined surface (e.g. an inclined conveyor), or a lifting mechanism (e.g. a section of conveyor moveable in the vertical direction).

The container receiving region may further comprise a container receiving surface configured to receive the target container from the handling member and deliver the target container to any one of the container ports and/or receive a free container from any one of the container ports for insertion into the stack by the handling member. The container receiving surface may be vertically moveable within the container receiving region independently of the handling member. The container receiving surface may be in the form of a conveyor.

The stack processing apparatus may further comprise a container processing region configured to receive the target container from the container port to allow items to be taken out of or placed into the container. The stack processing apparatus may further comprise a buffer region for temporarily storing one or more containers without blocking the container processing region. Containers may be transported between the container port, the container processing region and the buffer region using a conveyor arrangement or other transporting means. The container processing region and the buffer region may form part of the container path mentioned above.

The stack separating mechanism may further comprise a supporting member configured to releasably engage a container in the stack. The supporting member may be vertically moveable within the stack receiving region and configured to engage a container in the lower sub-stack while the separating member is separating the stack and/or while the handling member is extracting the target container. For example, the supporting member may engage the target container while the separating member is separating the stack and/or the supporting member may engage the container immediately below the target container while the handling member is extracting the target container. The supporting member helps the upper sub-stack to be separated more cleanly from the lower sub-stack and/or helps the target container to be extracted more cleanly from the lower sub-stack.

The stack processing apparatus may further comprise a control system comprising a container recognition system configured to determine the vertical position of one or more containers in the stack. The control system may be configured to vertically move the separating member and/or handling member based on the determined vertical positions. For example, the container recognition system may be configured to recognise the target container and the container immediately above the target container and determine their vertical positions in the stack.

The container recognition system may comprise a camera configured to capture one or more images of the containers in the stack and one or more processors configured to identify a visual identifier (e.g. a barcode, a QR code, etc.) on the containers. The container recognition system may comprise a data store comprising data associating the visual identifier of a container with a height dimension of the container. The camera may be configured to capture one or more images of the stack as it approaches the stack receiving region or when it is in the stack receiving region. The container recognition system may alternatively comprise an RFID reader configured to read an RFID tag on each container to identify the containers.

The stack separating mechanism may comprise a plurality of vertically arranged separating members. The vertically arranged separating members may be vertically moveable within the stack receiving region independently of each other to allow the vertically arranged separating members to move to and engage a plurality of containers in the stack and vertically lift the engaged containers relative to each other to separate the stack into more than two sub-stacks.

The stack receiving region may be configured to receive a predetermined maximum number of vertically stacked containers. The number of vertically arranged separating members may correspond to at least to the predetermined maximum number of vertically stacked containers to allow the vertically arranged separating members to move to and engage every container in the stack and vertically lift every container relative to each other to separate the stack in a plurality of sub-stacks, each sub-stack containing only one container.

### Stack Processing Station

A stack processing station is provided, comprising:
a first stack processing apparatus as defined above; and
a second stack processing apparatus as defined above;
wherein the first stack processing apparatus is connected to the second apparatus to allow a target container extracted from a stack in the first stack processing apparatus to travel to the second stack processing apparatus for insertion into a stack in the second stack processing apparatus.

For example, the first stack processing apparatus may comprise an out-feed port, the second stack processing apparatus may comprise an in-feed port, and the out-feed port may be connected to the in-feed port by a container path that allows a container to travel from the out-feed port to the in-feed port. The container path may comprise a container processing region at which items may be placed into or taken out of a container travelling along the path.

### Stack Processing System

A stack processing system is provided, comprising:
one or more vertical stacks of containers; and
one or more stack processing apparatuses or one or more stack processing stations as defined above.

The stack processing system may comprise one or more stack units of the storage and retrieval system defined above, which comprise the one or more vertical stacks of containers.

### Stack Processing Method

A method of processing a vertical stack of containers using the stack processing apparatus defined above is provided. The method comprises the steps of:
(i) vertically lifting a container within the stack to separate the stack into an upper sub-stack and a lower sub-stack;
(ii) horizontally extracting the container at the top of the lower sub-stack out of the stack or horizontally inserting a container between the upper sub-stack and the lower sub-stack; and
(iii) lowering the upper sub-stack onto the lower sub-stack to reform the stack.

The method may further comprise the steps of: after extracting the target container in step (ii), placing an item into and/or removing an item from the target container; and inserting the target container back into the stack or a different stack. The target container may be returned to the same stack in the same position from which it was extracted (e.g. the target container may be inserted back into the stack before step (iii) is carried out), or target container may be inserted into a different position in the same stack (e.g. by performing step (iii) and repeating step (i) at a different position in the stack). Alternatively, the target container may be inserted into a different stack at the stack processing apparatus.

The method may further comprise the step of placing an item into the free container before inserting the free container between the upper sub-stack and the lower sub-stack.

### BRIEF DESCRIPTION OF THE DRAWINGS

The present invention will now be described, by way of example only, with reference to the accompanying drawings, in which:

FIG. 1 is a perspective view of a stack unit comprising a vertical stack of containers located on top of a stand and a vehicle located underneath the stand.

FIGS. 2A and 2B are a sequence showing how a vehicle can move underneath the stand shown in FIG. 1.

FIG. 3 is an exploded perspective view of a container, a stand and a vehicle from above showing how they interface with each other.

FIG. 4 is an exploded perspective view of a container, a stand and a vehicle from below showing how they interface with each other.

FIGS. 5A and 5B are a sequence showing how a lifting mechanism of the vehicle moves from a lowered position to a raised position to lifting the stand shown in FIG. 1.

FIG. 6 is a schematic diagram of a storage and retrieval system comprising a filling station, a storage area and a picking station.

FIG. 7 is a perspective view of an example filling station.

FIG. 8 is a perspective view of an example storage area.

FIGS. 9-18 are a sequential set of drawings showing a stack processing apparatus from a perspective view operating to extract a target container from a vertical stack of containers.

FIG. 19 illustrates of the stack processing apparatus of FIGS. 9-18 further comprising a supporting member for supporting a stack when it is being separated and/or when a target container is being extracted.

FIG. 20 illustrates the stack processing apparatus of FIGS. 9-18 further comprising a container processing region and a buffer region.

FIG. 21 illustrates the stack processing apparatus of FIGS. 9-18 further comprising an out-feed port and an in-feed port connected by a container path.

FIG. 22 illustrates the stack processing apparatus of FIGS. 9-18 further comprising an out-feed port and an in-feed port connected by a container path.

FIG. 23 illustrates a stack processing station comprising two stack processing apparatuses of FIGS. 9-18 and a container path connecting them.

FIG. 24 illustrates the stack processing apparatus of FIGS. 9-18 further comprising a vision system.

FIG. 25 illustrates another stack processing apparatus.

FIG. 26 illustrates the stack processing apparatus of FIG. 25 after receiving a stack of containers.

FIGS. 27-29 are a sequential set of drawings showing how the stack processing apparatus of FIG. 25 engages and separates the containers in the stack.

FIGS. 30 and 31 are a sequential set of drawings showing how the stack processing apparatus of FIG. 25 extracts a target container from the stack.

### DETAILED DESCRIPTION

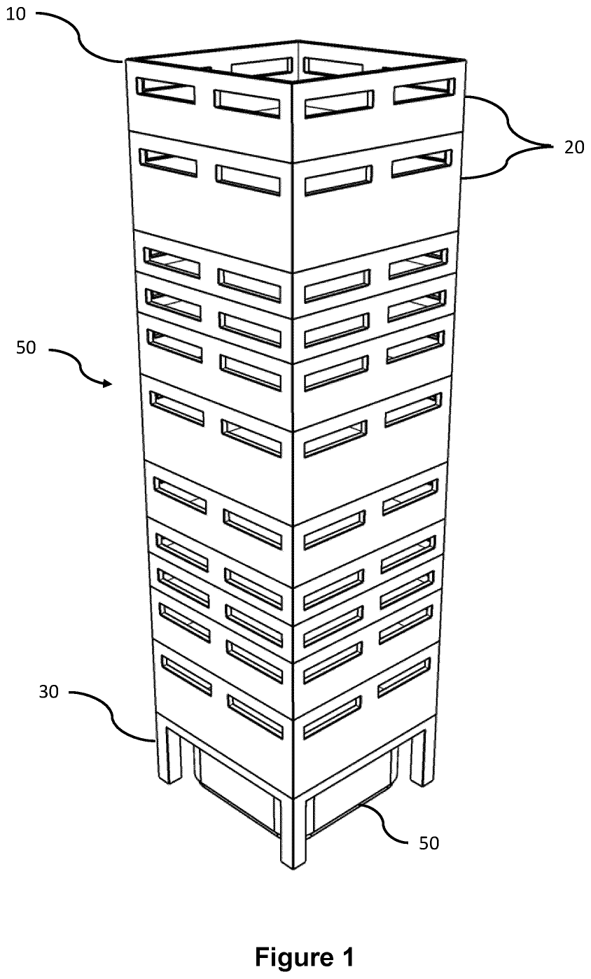

FIG. 1 shows a stack of containers 10. The stack of containers 10 comprises a plurality of individual containers 20 that are vertically stacked directly on top of each other. The containers may comprise cooperating features (e.g. protrusions and recesses) on the top and bottom to allow the containers 20 to stack more easily and stably. As shown in FIG. 1, the stack 10 may comprise containers 20 of different heights. The different heights may be predetermined, i.e. the containers forming the stack are chosen from a set of containers having a plurality of predetermined heights.

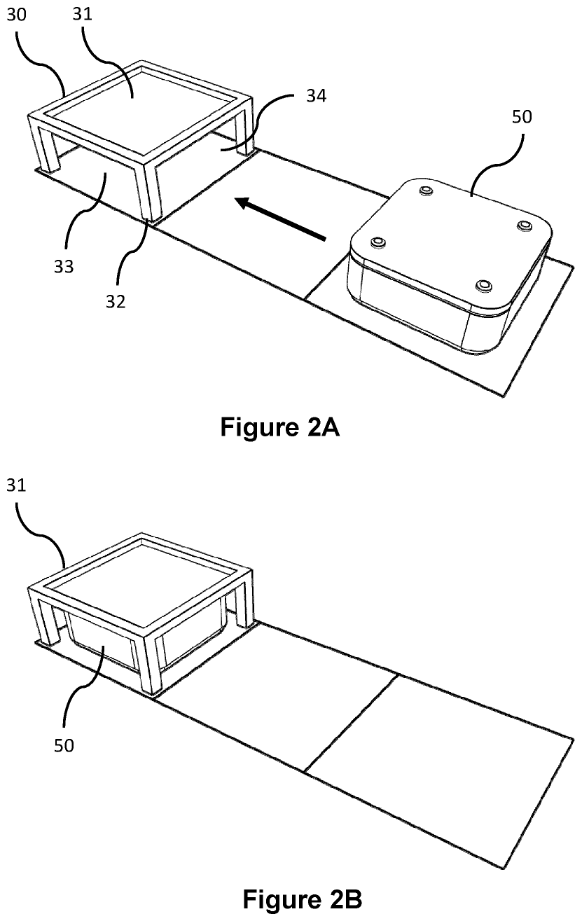

The stack 10 is located on top of a stand 30 which raises the stack 10 above the ground. The stack 10 on top of the stand 30 in combination form a stack unit 40. The stand 30 (shown more clearly in FIG. 2) comprises a stand top 31 on which the stack 10 is located and legs 32 extending downwardly from each corner of the stand top 31. The stand top 31 and legs 32 define a space 33 underneath the stand top 31 that is accessible from the side via one or more side openings 34 defined between adjacent legs 32. In the example shown in FIG. 1, the stand top 31 has a rectangular (square) shape with four legs 32 extending downwardly from the corners and a side opening 34 on each side of the stand 30.

FIG. 1 also shows a vehicle (e.g. an AGV or AMR) 50 underneath the stand 30. The purpose of the vehicle 50 is to lift and transport the stack unit 40 to different locations. The vehicle 50 comprises a driving mechanism configured to allow the vehicle 50 to move in a plurality of directions. For example, the driving mechanism may be configured to allow the vehicle to move forwards and backwards in at least two orthogonal directions. The driving mechanism may allow the vehicle rotate about a vertical axis to allow the vehicle to change direction.

As shown in FIGS. 2A and 2B, the vehicle 50 is dimensioned so that it can enter and occupy the space 33 underneath the stand top 31 via any of the side openings 33. In particular, the vehicle 50 is dimensioned such that the vehicle 50 can completely fit in the space 33 in the vertical direction. The vehicle 50 is also preferably dimensioned so that it does not laterally extend beyond the stand top 31 when it is occupying the space 33.

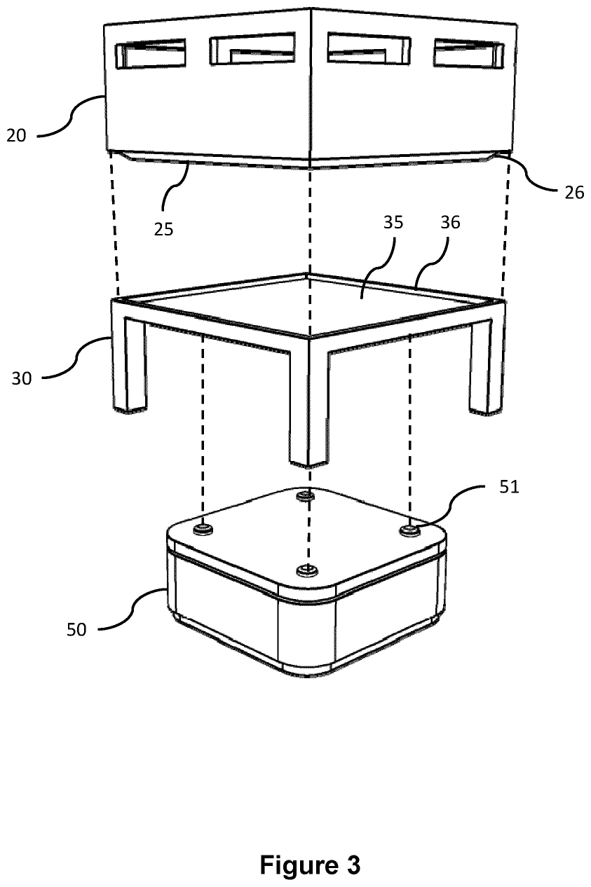

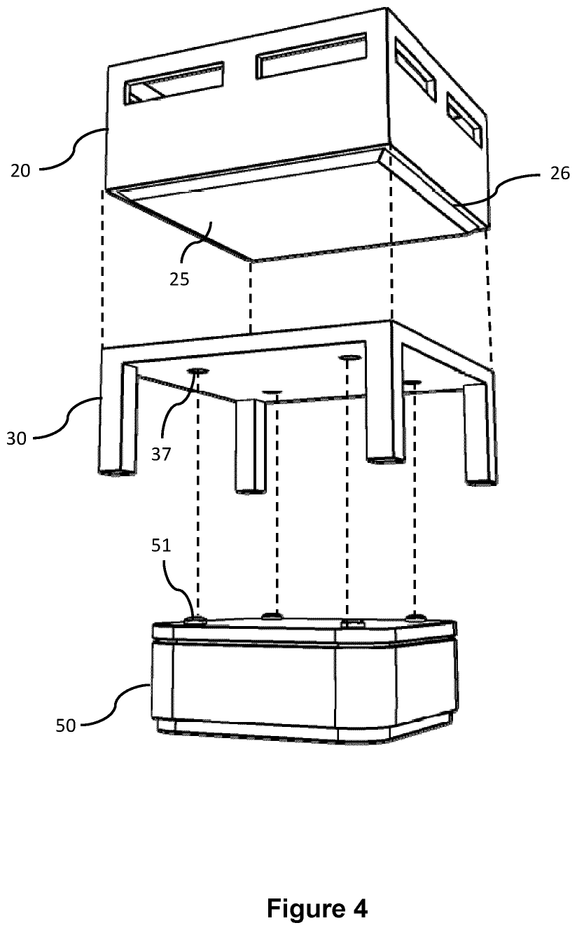

FIG. 3 and FIG. 4 are exploded views of a container 20, the stand 30 and the vehicle 50 showing how they interface with each other with interlocking features. The top of the stand top 31 comprises a recessed surface 35 for receiving a corresponding protruding surface 25 on the bottom of the container 20 so that the stack 10 rests more securely on the stand 30. The top of the stand top 31 also comprises an inclined surface 36 around the perimeter of the recess 35 which cooperates with a corresponding inclined surface 26 around the perimeter of the protruding surface 25 of the container 20 to help the container 20 locate itself onto the top of the stand 30.

The top of the vehicle 50 and the bottom of the stand top 31 also comprise interlocking features. In particular, the top of the vehicle 50 comprises upwardly extending protrusions 51 which interlock with corresponding recesses 37 in the underside of the stand top 31 so that the stand 30 rests more securely on the vehicle 50 when it is being lifted.

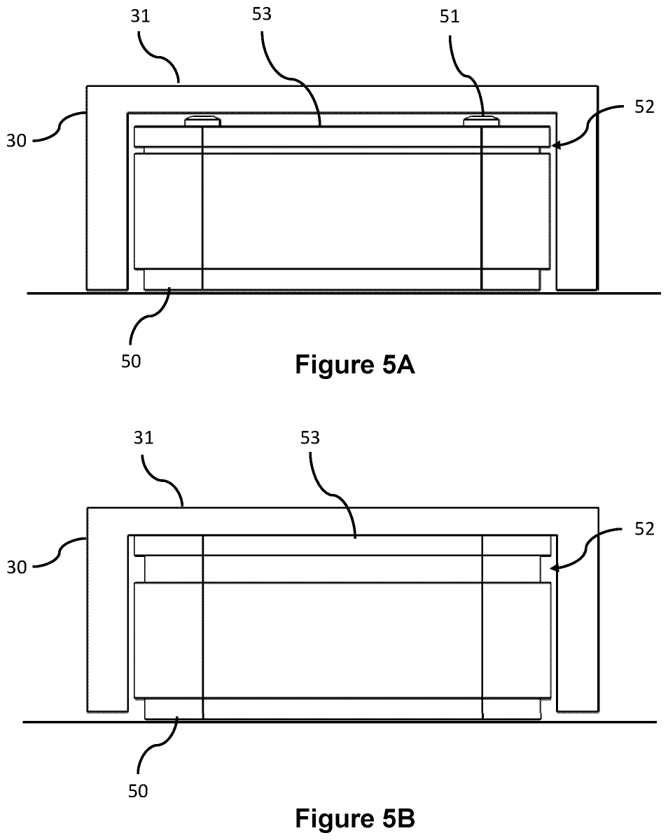

FIGS. 5A and 5B show a lifting mechanism 52 of the vehicle 50 for lifting the stand 30 once the vehicle 50 is positioned underneath the stand top 31. The vehicle 50 comprises a lifting surface 53 (on which the protrusions 51 are located) which is vertically moveable relative to the body of the vehicle 50 between a lowered position and a raised position. In the lowered position shown in FIG. 5A, the lifting surface 53 is not engaged with the stand 30. In the raised position shown in FIG. 5B, the lifting surface 53 is engaged with the underside of the stand top 31 and the overall height of the vehicle 50 increased such that the stand 30 is lifted completely off the ground and is solely supported by the lifting surface 52. Once the lifting surface 52 is the in the raised position, the vehicle 50 can transport the stack unit 40 to a desired location. Once the stack unit 40 has been transported to the desired location, the lifting surface 52 can be moved to the lowered position to place the stack unit 40 back on the ground. The vehicle 50 can then exit space 33 and move to a different location (e.g. to a different stack unit 40).

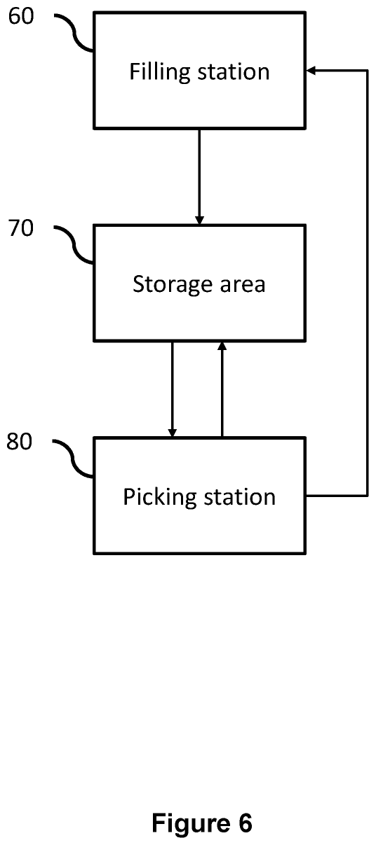

A plurality of stack units 40 may form the basis of a storage and retrieval system in which items are stored in the containers 20 of the stack units 40 for later retrieval. FIG. 6 is a schematic diagram of a storage and retrieval system comprising a filling station 60, a storage area 70 and a picking station 80. The arrows indicate the potential paths of a container 20 through the storage and retrieval system, starting at the filing station 60.

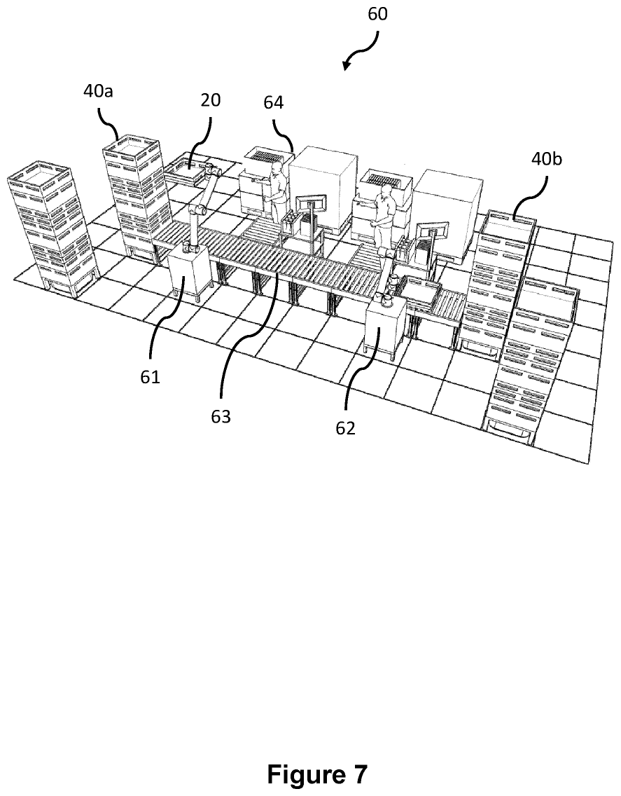

FIG. 7 shows an example filling station 60 (which may be one of a plurality of filling stations 60) of the storage and retrieval system. At the filling station 60, items to be stored are placed into empty or partially full containers 20, which are then formed into new stack units 40 or transferred onto existing stack units 40. The containers 20 within a particular stack unit 40 may all hold the same item, or they may hold different items. Stack units 40a containing empty or partially full containers 20 are transported to the filling station 60 by vehicles 50. The filling station 60 comprises a robotic de-stacking arm 61 which picks up a container 20 from the top of the stack unit 40a and places it onto a conveyor 63. The conveyor 63 transports the container 20 to a filling area 64 at which a worker places items into the container 20. The conveyor then transports the filled container 20 to a robotic stacking arm 62 which picks up the container 20 and places it on top of an existing stack unit 40b, or on top of a stand 30 to form a new stack unit 40. A vehicle 50 then moves the stack unit 40b from the filling station 60 to the storage area 70.

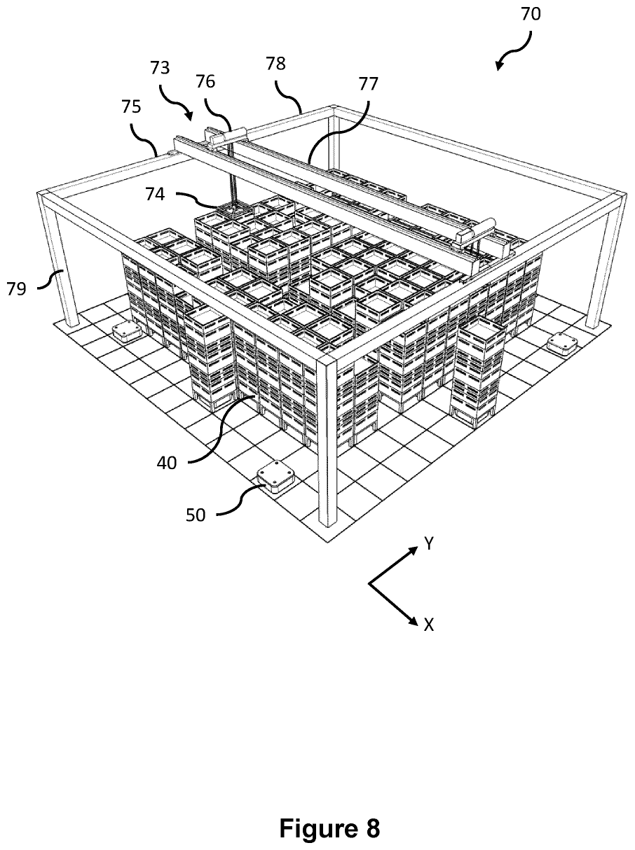

FIG. 8 shows an example storage area 70 of the storage and retrieval system in which the floor is divided into an array of grid cells 71 arranged in perpendicular X and Y directions. FIG. 8 shows the grid cells 71 marked on the floor of the storage area 70 for clarity, but in reality, the grid cells 71 do not need to be physically marked on the floor. Each grid cell 71 can be occupied by a stack unit 40 such that when a plurality of stack units 40 are arranged on the grid cells 71, the stack units 50 form a grid pattern. Not all of the grid cells 71 need to be occupied at any one time and there may be unoccupied grid cells 71, groups of unoccupied grid cells 71, and/or rows and/or columns of unoccupied grid cells 71 within the storage area 70. As shown in FIG. 8, the side openings 33 of the stack units 40 on adjacent grid cells 71 can be aligned to form a first set of open channels running through the grid pattern of stack units 40 and a second set of open channels running through the grid pattern of stack units 40, whereby the first set and the second set of open channels run perpendicular to each other. The vehicles 50 can use the open channels to move to different locations within the storage and retrieval system more efficiently because the vehicles 50 can move “through” the grid pattern of stack units 40, rather than having to move around the outer perimeter of the grid pattern of stack units 40.

FIG. 8 further shows a container lifting device 73 arranged above the stack units 40 in the storage area 70. The container lifting device 73 comprises one or more container grabbers 74 that are moveable in the vertical direction and in the horizontal X- and Y-directions to allow the container grabber 74 to lift a container 20 from the top a stack unit 40 and place it down on top of another stack unit 40. The container grabber 74 comprises a grabbing mechanism that can selectively engage features of the top and/or sides of a container 20 to allow the container grabber 74 to releasably hold the container 20. In this illustrated example, movement and support of the container grabbers 74 is achieved by a gantry structure 75. The gantry structure 75 comprises a hoist 76 for vertically moving the container grabber 74 up and down for lifting and lowering a container 20 respectively. The hoist 76 is moveable along a first set of horizontal beams 77 in the horizontal X-direction (e.g. using rollers and tracks) and the first set of horizontal beams 77 are movable along a second set of horizontal beams 78 in the Y-horizontal direction (e.g. using rollers and tracks). The second set of horizontal beams 78 are supported above the stack units 40 by vertical supports 79. In this way, the container grabber 74 can be moved to a particular horizontal and vertical position by horizontally moving the first set of horizontal beams 77 relative to the second set of horizontal beams 78, horizontally moving the hoist 76 relative to the first set of horizontal beams 77, and vertically moving the container grabber 74 relative to the hoist 76.

One purpose of the container lifting device 74 is to re-arrange the containers 20 among the stack units 40 while the stack units 40 are being held within the storage area 70. For example, the container lifting device 74 can move a container 20 from a stack unit 40 in the middle of a group of stacks units 40 to a stack unit 40 located at the edge of the group of stack units 40. This allows for a more efficient system because a stack unit 40 at the edge of a group of stack units can be transported away by a vehicle 50 more quickly compared to a stack unit 40 at the centre of a group of stack units. Furthermore, in the context of an a item ordering system, the container lifting device 74 can rearrange the containers 20 to create a single stack unit 40 (or a minimal number of stack units 40) comprising the containers 20 holding the items of one or more orders so that the number of trips taken by the vehicles 50 between the storage area 70 and the picking station 80 can be minimised.

At the picking station 80, items are retrieved from the stack units 40. The picking station 80 can be similar to the example filling station 60 illustrated in FIG. 7. In particular, when an item is required from the storage area 70, the stack unit 40 of the container 20 holding that item is transported from the storage area 70 to the picking station 80 by a vehicle 50. At the picking station 80, the container 20 holding the item is removed from the stack unit 40 by a robotic arm and transported by a conveyor to a picking area at which a worker removes one or more items from the container 20 and places them into a delivery container for delivery to a customer. The container 20 is then placed back onto the same or a different stack unit 40 by a robotic arm and the stack unit 40 is transported by a vehicle 50 back to the storage area 70. Alternatively, the stack unit 40 may be transported to the filling station 60 if one or more containers 20 in the stack unit 40 need to be refilled with items.

In the filling station 60 and the picking station 80 described above, the de-stacking and stacking of the containers 20 can be carried out manually instead of using robotic arms and the filling and picking of items into and out of the containers 20 can be carried out using robotic arms instead of manually.

In addition to the floor of the storage area 70 being divided into grid cells 71, the floor of the area around the filling station 60 and the picking station 80 can also be divided into grid cells. The grid cells can act as a coordinate system for providing unique location references for the stack units and the vehicles 50.

Movement of the vehicles 50 between the filling station 60, the storage area 70 and the picking station 80 can be controlled by a central control system that is communicably coupled to each vehicle. In particular, the central control system comprises a processing unit comprising one or more processors that communicate wirelessly with the vehicles 50 via one or more wireless transmitters and receivers. The processing unit may form part of a computing device that is located within the same physical location as the filling station 60, storage area 70 and picking station 80, or they may form part of a computing device that is remotely located, e.g. a cloud-based server. The processing unit can command each vehicle 50 to move to a particular target location (e.g. a particular grid cell reference) within the storage and retrieval system and raise or lower the lifting mechanism 52. The processing unit may plan the full route of each vehicle 50 to its target destination and command the movement of each vehicle 50 accordingly, or each vehicle 50 may comprise its own local control system with a local routing system so that each vehicle 50 can plan its own route to a target location once the target location has been sent to the vehicle 50 by the central control system. Each vehicle 50 can also update the central control system with its current location (e.g. grid cell reference) and its current status (e.g. the status of the lifting mechanism 52).

The central control system can also comprise a data store (e.g. a hard disk drive or solid state drive) for storing data relating to one or more of: the location (e.g. grid cell reference) of each stack unit 40, the containers 20 within each stack unit 40, the position of each container 20 within each stack 10 of each stack unit 40, and the items within each container 20.

For example, each stack unit 40 can be associated with a unique identifier, e.g. a QR code, barcode, or RFID tag located on each stand 30. In the data store, the unique identifier of each stack unit 40 can be associated with the current location of each stack unit 40. The unique identifiers of the stack units 40 can be read by an appropriate reader (e.g. a camera, optical/laser scanner or RFID reader) located at one or more locations within the storage and retrieval system (e.g. at the filling station 60, the storage area 70, the picking station 80 and/or any areas therebetween). The processing unit of the central control system can read data from the data store to direct vehicles 50 to a particular stack unit 40 at a particular location and write data to the data store to update the data store with the new location of a stack unit 40 after it has been moved. Each vehicle 50 can also comprise an appropriate reader for reading the unique identifiers of the stack units 40 so that each vehicle 50 can determine that is it moving the correct stack unit 40 as commanded by the central control system. If a vehicle 50 determines that the stack unit 40 at a target location set by the central control system does not match the stack unit 40 expected by the central control system, then the vehicle 50 can send an error signal to the central control system, which may blacklist that target location so that no vehicles 50 are sent to that target location until the discrepancy is resolved.

Each container 20 can also be associated with a unique identifier, e.g. a QR code, barcode, or RFID tag located on each container 20. In the data store, the unique identifier of each container 20 can be associated the unique identifier of the respective stack unit 40 in which each container 20 is located. The unique identifiers of the containers 20 can be read by an appropriate reader (e.g. a camera, optical/laser scanner or RFID reader) located at one or more locations within the storage and retrieval system (e.g. at the filling station 60, the storage area 70, the picking station 80 and/or any areas therebetween). For example, a reader can be located at a filling station 60 so that when new stack units 40 are formed, or when a new container 20 is placed on an existing stack unit 40, the reader can inform the central control system so that the container composition of the new or existing stack unit 40 is updated in the data store. Similarly, a reader can be located at a picking station 80 so that when a container is removed from a stack unit 40 to allow the items within the container 20 to be picked, the container composition of the stack unit 40 can be updated in the data store.

In the data store, the unique identifier of each container 20 can also be associated with its position within the stack of containers 10 in which the container 20 is located. For example, a container 20 at the bottom of a stack of containers 10 may be in position “1”, a container 20 in the next position up may be in position “2” and so on. This information can be communicated to a robotic arm or human operator at a picking station 80 to allow the robotic arm or human operator to know which container 20 needs to be accessed from a stack unit 40 before picking an item.

The data store may also store data relating to the items stored within each container 20. For example, at a filling station 60, items having a barcode or other identifier can be scanned by an appropriate reader before being placed into a container 20. The reader can communicate with the central control system so that the data store can associate the unique identifier of each container 20 with the identifier of each item that has been placed into the container 20. Similarly, at a picking station 80, items that are picked out of a container 20 can be scanned and communicated to the central control system so that the contents of the container 20 can be updated in the data store. In this way, the storage and retrieval system can keep track of the location and quantity of each item in the system.

The storage and retrieval system can be used in the context of an item ordering system, e.g. an online retail system. When an order comprising an item is received from a customer, the processing unit of the central control system looks up the data in the data store to determine the container 20 in which the item resides and the location of the stack unit 40 in which that container 20 resides. The processing unit then commands a vehicle 50 to retrieve that stack unit 40 from the storage area 70 and transport it to a picking station 80. At the picking station 80, the container 20 containing the item is retrieved from the stack unit 40 so that the item can be picked out of the container 20 and eventually delivered to the customer. If the order comprises a plurality of different items, then the central control system can command the vehicle 50 to transport all of the required stack units 40 one-by-one to the picking station 80, or the central control system can command a plurality of vehicles 50 to transport a plurality of the required stack units 40 to the picking station 80. Referring back to FIG. 8, the container lifting device 64 can be used re-arrange containers 20 in the storage area 70 so that the containers 20 required for an order are re-arranged into a single stack unit 40, or at least re-arranged into fewer stack units 40 than the number of required containers 20. In this way, the vehicles 50 can take fewer trips between the storage area 70 and the picking station 80, thereby increasing the efficiency of the system. To improve efficiency further, multiple orders containing at least some of the same items can also be grouped together so that a container arriving at a picking station 80 can be used to fulfil multiple orders at the same time.

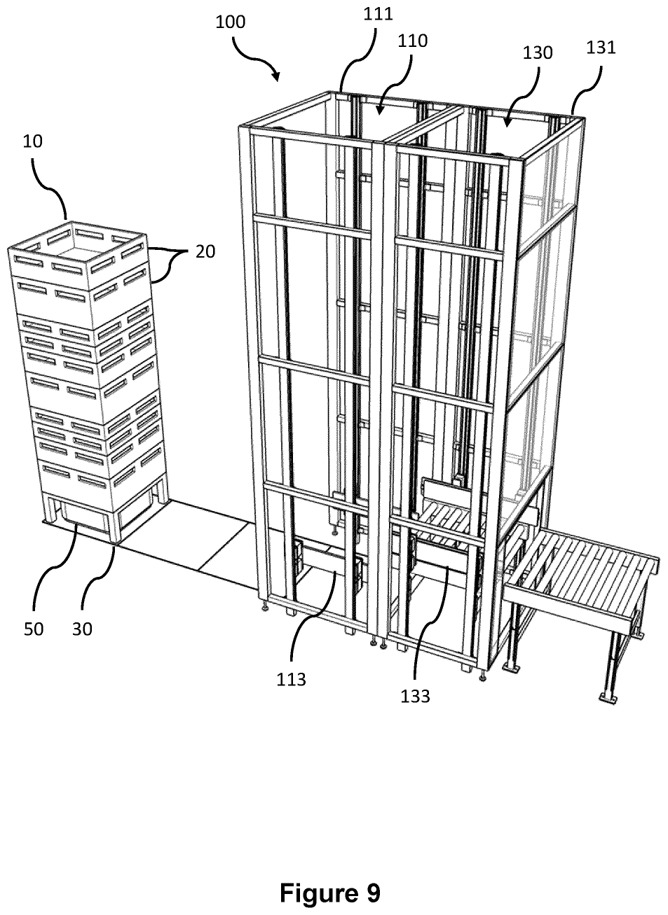

FIG. 9 shows a stack processing apparatus 100 that may be used at the filling station 60, or the picking station 80, for example. The stack processing apparatus 100 can extract containers from a vertical stack of containers and/or insert containers into a vertical stack of containers. The stack may be a stack 10 in a stack unit 40 as depicted in FIG. 1, or any other vertical stack of containers (e.g. a stack 10 without a stand 30).

Each container 20 in the stack 10 comprises features that allow the container 20 to be engaged from one or more sides and lifted. For example, each container 20 may comprise one or more apertures, recesses, protrusions, rims, etc. Each container 20 is preferably open at the top to allow items to be placed into or taken out of the container 20.

The stack 10 may be transported to the stack processing apparatus 100 by a vehicle 50 as described above. Alternatively, the stack 10 may be transported to the stack processing apparatus 100 using other transportation means, such as a conveyor (with or without the stand 30), or a manually operated vehicle.

FIGS. 9-18 show a sequence in which the stack processing apparatus 100 extracts a target container 21 out of the stack of containers 10. A target container 21 is defined as a container that is to be extracted out of a stack 10.

The stack processing apparatus 100 comprises a stack receiving region 110. The stack receiving region 110 is configured to receive a stack of containers 10. The stack receiving region 110 is defined by a columnar frame structure 111 comprising an opening that allows the stack of containers 10 to be moved into the stack receiving region 110. The frame structure 111 is not limited to any particular shape or configuration, provided it can support the various components in the stack receiving region 110 that are described further below.

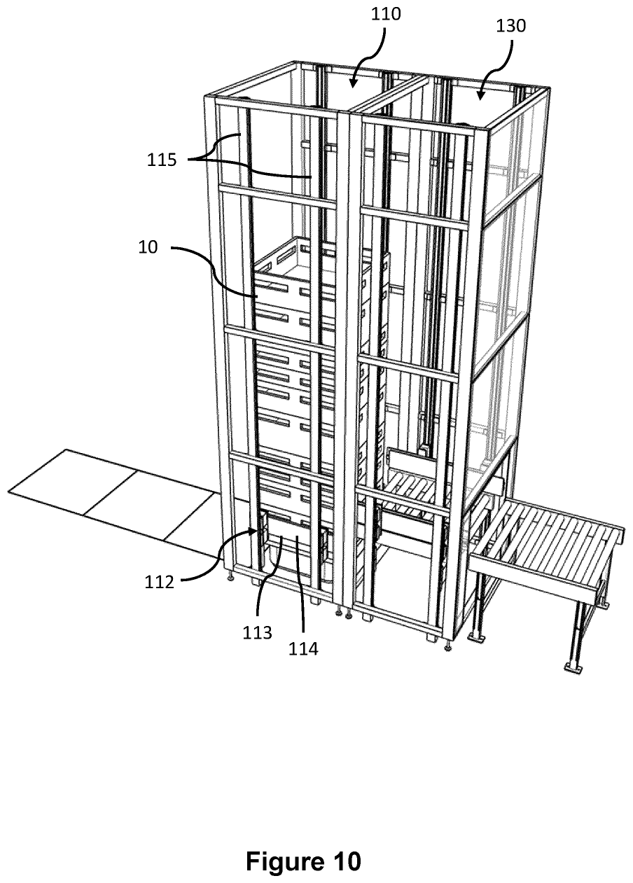

FIG. 10 shows the stack processing apparatus 100 once the stack 10 has been received in the stack receiving region 110.

The stack receiving region 110 comprises a stack separating mechanism 112 comprising a separating member 113. The separating member 113 is vertically moveable within the stack receiving region 110 to allow the separating member 113 to engage any container 20 in the stack 10. In this example, the separating member 113 is vertically moveable on a pair of vertical rails 115 that are mounted on one side of the frame structure 111 defining the stack receiving region 110. The separating member 113 may move on the rails 115 using known means such as a ball screw mechanism or a belt drive. A pair of vertical rails 115 is provided for stability, but the separating member 113 may move on a single vertical rail or more than two vertical rails instead.

The separating member 113 is configured to releasably engage a container 20 in the stack 10 so that once engaged, the container 20 can be vertically moved by vertically moving the separating member 113. The separating member 113 may comprise any suitable mechanism for engaging the container 20. For example, the separating member 113 may comprise one or more engaging features 114 configured to move towards and away from the stack 10 to engage and release corresponding features on a container 20 respectively. The engaging features 114 may, for example, be one or more protrusions (e.g. extending in a horizontal direction towards the stack), recesses, apertures, etc. The separating member 113 may comprise one or more actuators for moving the engaging features towards and away from the stack. The engaging features 114 may be moved relative to a portion of the separating member 113, or the separating member 113 may move as a whole towards and away from the stack 10. The actuator may be a linear actuator. The actuator may be any suitable type of actuator, e.g. pneumatic, hydraulic, electric, etc.

The stack separating mechanism 112 further comprises a similar second separating member 113 moveable on a second pair of vertical rails 115 on an opposing side of the frame structure 111 defining the stack receiving region 110 so that the stack 10 is located between the opposing pair of separating members 113. The opposing pair of separating members 113 can be configured to vertically move together and engage a container between them using the engaging features 114 described above. Alternatively, the opposing pair of separating members 113 may act as a clamp to engage opposing sides of a container 20 by friction.

Although in this example the separating members 113 are provided as an opposing pair, the stack separating mechanism 112 is not limited to this arrangement and may instead have a separating member 113 on only one side of the stack 10 (to engage and lift a container in a cantilever fashion), a non-opposing pair of separating members 113 (e.g. arranged at adjacent sides of the stack) or more than two separating members 113 (e.g. arranged on more than two sides of the stack).

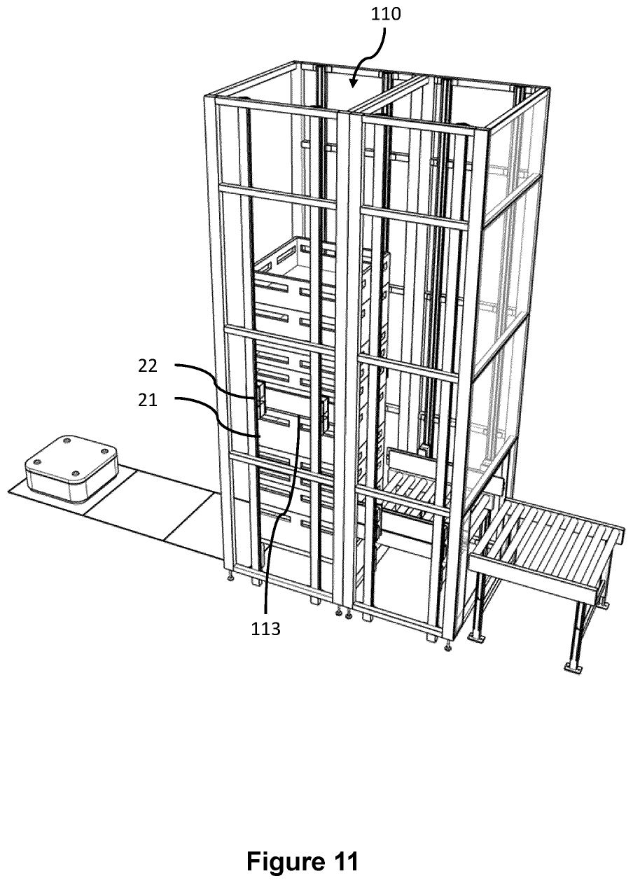

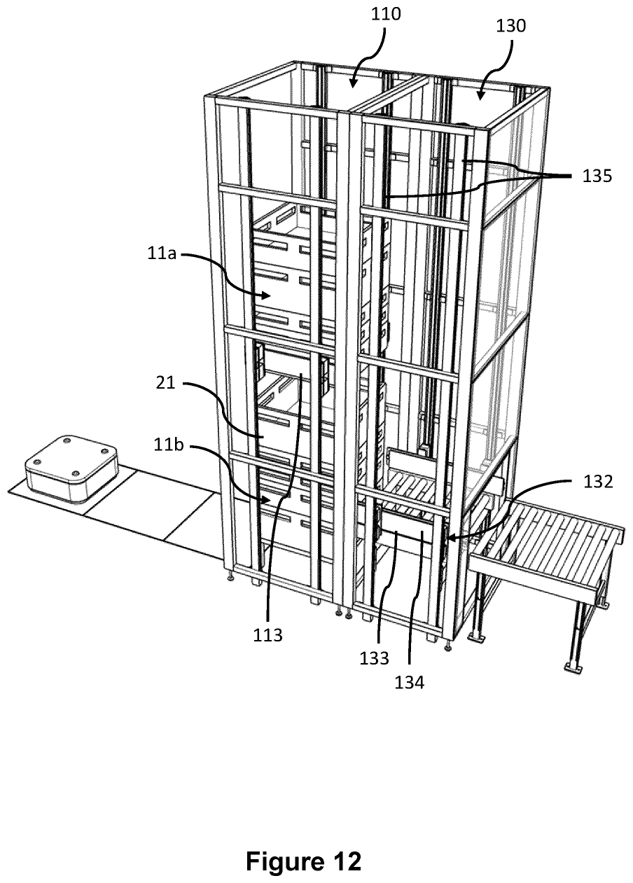

Once the stack 10 has been received in the stack receiving region 110, the stack separating mechanism 112 operates to vertically move the separating members 113 to the vertical position of the container 22 immediately above the target container 21, as shown in FIG. 11. The separating members 113 then engage the container 22 and move vertically upwards to lift the container 22 (and any containers that are stacked on top of the container) away from the target container 21. The state of the stack processing apparatus 100 at this point is shown in FIG. 12. In FIG. 12, it can be seen that the stack 10 has been vertically separated into two sub-stacks 11—an upper sub-stack 11a and a lower sub-stack 11b. The target container 21 is now exposed at the top of the lower sub-stack 11b.

The stack processing apparatus 100 further comprises a container receiving region 130 horizontally adjacent to the stack receiving region 110. The container receiving region 130 is configured to receive target containers 21 extracted from the stack receiving region 110. In this example, the container receiving region 130 is defined by a columnar frame structure 131, similar to the stack receiving region 110. The frame structure 131 is not limited to any particular shape or configuration, provided it can support the various components in the container receiving region 130 that are described further below.

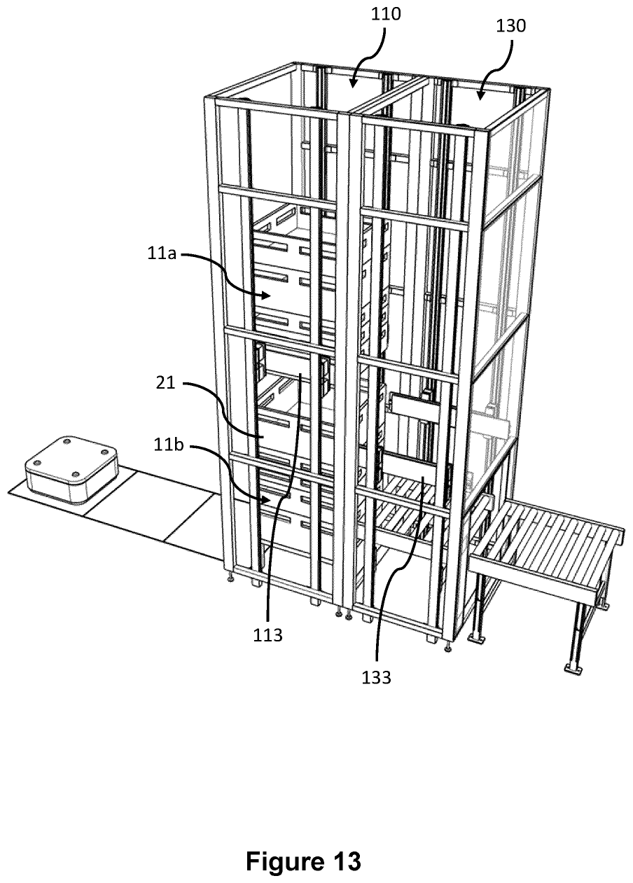

The container receiving region 130 comprises a container handling mechanism 132 comprising a handling member 133. The handling member 133 is vertically moveable within the container receiving region 130 to allow the handling member 133 to reach the vertical position of the target container 21, as shown in FIG. 13. Similar to the separating member 113, the handling member 133 is vertically moveable on a pair of vertical rails 135 that are mounted on one side of the frame structure 131 defining the container receiving region 130. The handling member 133 may move on the rails 135 using known means such as a ball screw mechanism or a belt drive. A pair of vertical rails 135 is provided for stability, but the handling member 133 may move on a single vertical rail or more than two vertical rails instead.

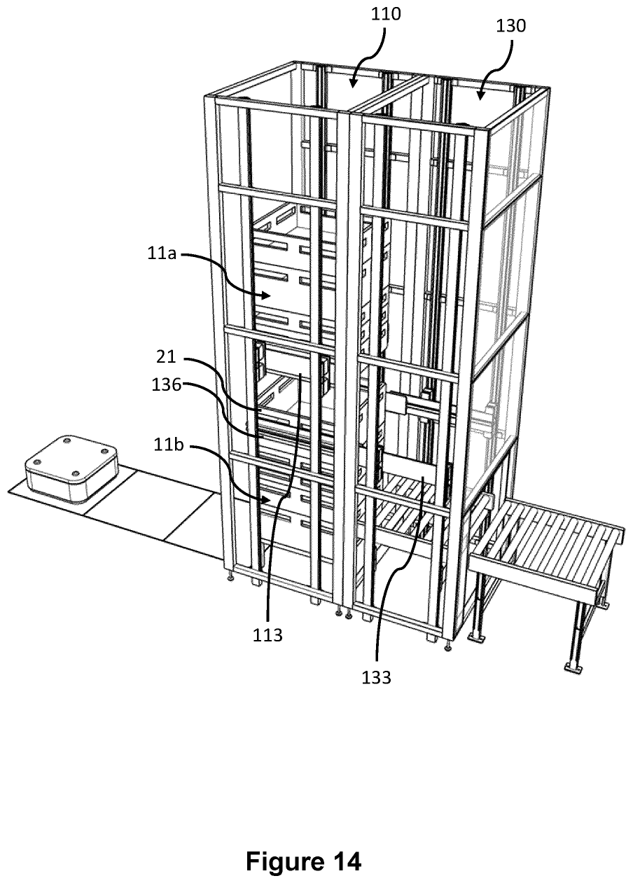

The handling member 133 is also horizontally moveable to allow the handling member 133 to engage and horizontally extract the target container 21 out of the stack 10. In particular, at least a portion of the handling member 133 is horizontally moveable between the container receiving region 130 and the stack receiving region 110. In this example, the handling member 133 comprises a retractable arm 136 configured to linearly extend and retract in a horizontal direction between the container receiving region 130 and the stack receiving region 110. FIG. 14 shows the arm 136 in an extended state such that the arm 136 is in the stack receiving region 110 and adjacent to the target container 21.

The handling member 133 is configured to releasably engage the target container 21 in the stack 10 so that once engaged, the target container 21 can be vertically and/or horizontally moved by vertically and/or horizontally moving the handling member 133 respectively. Similar to the separating member 113, the handling member 133 may comprise any suitable mechanism for engaging the target container 21. For example, the handling member 133 may comprise one or more engaging features 134 configured to move toward and away from the stack 10 to engage and release corresponding features on a container 20 respectively. The engaging features 134 may, for example, be one or more protrusions (e.g. extending in a horizontal direction towards the stack), recesses, apertures, etc. The handling member 133 may comprise one or more actuators for moving the engaging features towards and away from the stack. The engaging features 134 may be moved relative to a portion of the handling member 133, or the handling member 133 may move as a whole towards and away from the stack 10. The actuator may be a linear actuator. The actuator may be any suitable type of actuator, e.g. pneumatic, hydraulic, electric, etc.

Similar to the stack separating mechanism 112, the container handling mechanism 132 further comprises a similar second handling member 133 moveable on a second pair of vertical rails 135 on an opposing side of the frame structure 131 defining the container receiving region 130. The opposing pair of handling members 133 can be configured to vertically move together and engage the target container 21 between them using the engaging features 134 described above.

Although in this example the handling members 133 are provided as an opposing pair, the container handling mechanism 131 is not limited to this arrangement and may instead have a handling member 133 on only one side of the stack 10 (to engage and support the target container 21 in a cantilever fashion), a non-opposing pair of handling members 133 (e.g. for engaging adjacent sides of the target container 21) or more than two handling members 133 (e.g. for engaging more than two sides of the target container 21).

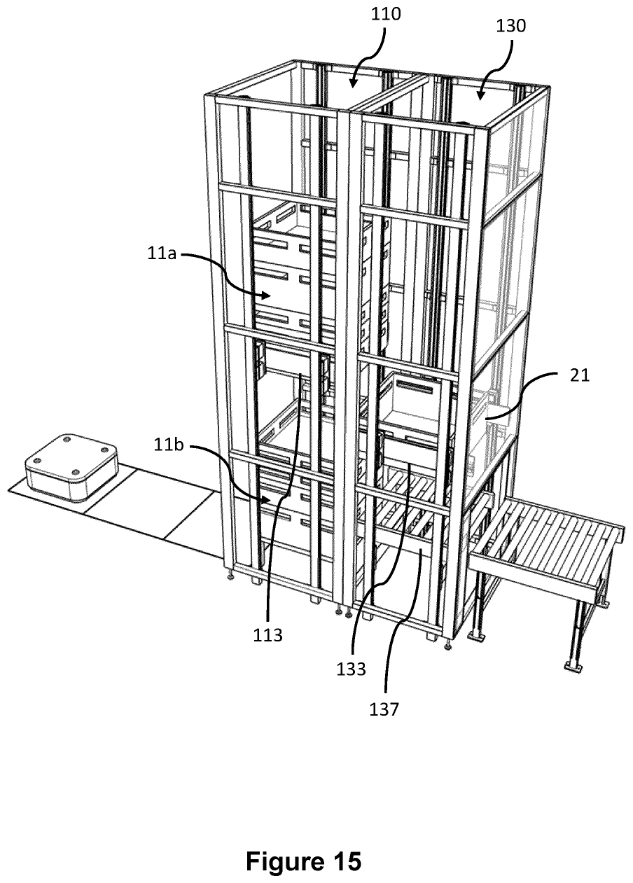

Once the handling members 133 have engaged the target container 21, the arms 136 of the handling members 133 are then configured to retract from the stack receiving region 110 to the container receiving region 130 to horizontally extract the target container 21 out of the stack 10 and into the container receiving region 130. FIG. 15 shows the stack processing apparatus 100 in the state where the target container 21 has been extracted to the container receiving region 130 by the handling members 133.

Before horizontally moving the target container 21 out of the stack 10, the handling members 133 may be configured to first move vertically upwards so that the target container 21 is clear of the container below it. This may be required if the containers 20 comprise interlocking stacking features, for example.

The container receiving region 130 further comprises a container receiving surface 137 for receiving the target container 21 from the handling members 133 after it has been extracted from the stack 10. In this example, the container receiving surface 137 is in the form of a receiving conveyor (e.g. a roller conveyor or a belt conveyor) that is vertically moveable within the container receiving region 130, independently of the handling members 133. The receiving conveyor 137 may move vertically on the same rails 135 as the handling members 133 or on a different rail or set of rails, using known means such as a ball screw mechanism or a belt drive.

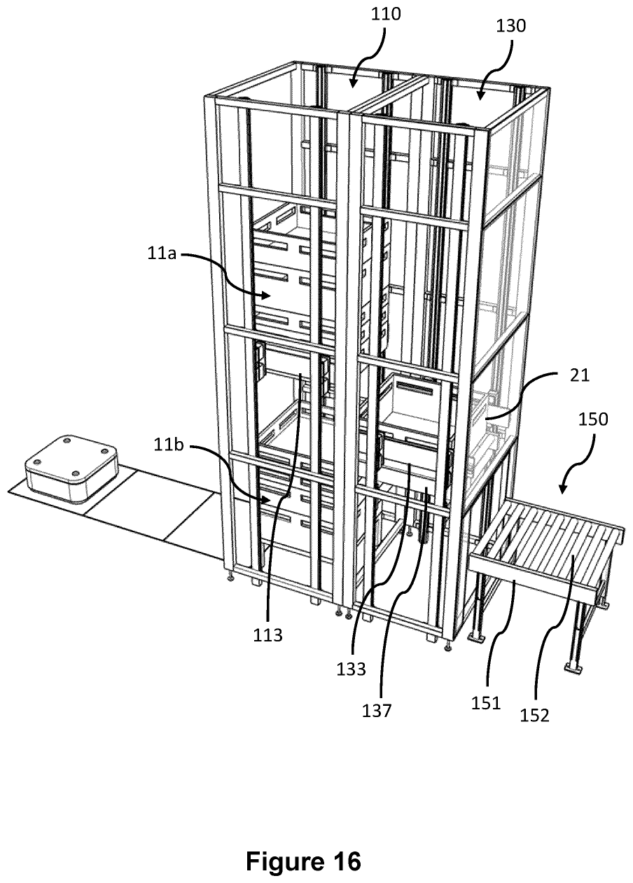

As shown in FIG. 16, the receiving conveyor 137 is configured to move vertically to meet the target container 21. Once the receiving conveyor 137 has reached the target container 21, the handling members 133 are configured to release the target container 21 (e.g. by moving the engaging features 134 away from the target container 21) so that the target container 21 rests freely on the receiving conveyor 137.

The receiving conveyor 137 can be configured to move vertically towards the vertical position of the target container 21 at any point during the operation of the handling members 133. For example, the receiving conveyor 137 may start moving towards the target container 21 only once the target container 21 has been fully extracted from the stack 10, or the receiving conveyor 137 may start moving towards the handling members 133 so that when the target container 21 has been fully extracted out of the stack 10, the receiving conveyor 137 is already at or near the correct vertical position to receive the target container 21.

The stack processing apparatus 100 further comprises a container port region 150 horizontally adjacent to the container receiving region 130 for receiving the target container 21 from the container receiving region 130. The container port region 150 comprises a container port 151 configured to receive the target container 21 from the container receiving region 130. The container port 151 comprises a port surface 152 that can receive the target container 21. The port surface 151 may be fixed at a predetermined vertical position, e.g. a height that is convenient for a human operator or robotic device to access the contents of the target container 21. In this example, the port surface 152 is in the form of a conveyor (e.g. a roller conveyor or a belt conveyor) but the port surface 152 may take other forms, such as a static platform, a manually operated vehicle, an automatically guided vehicle, etc.

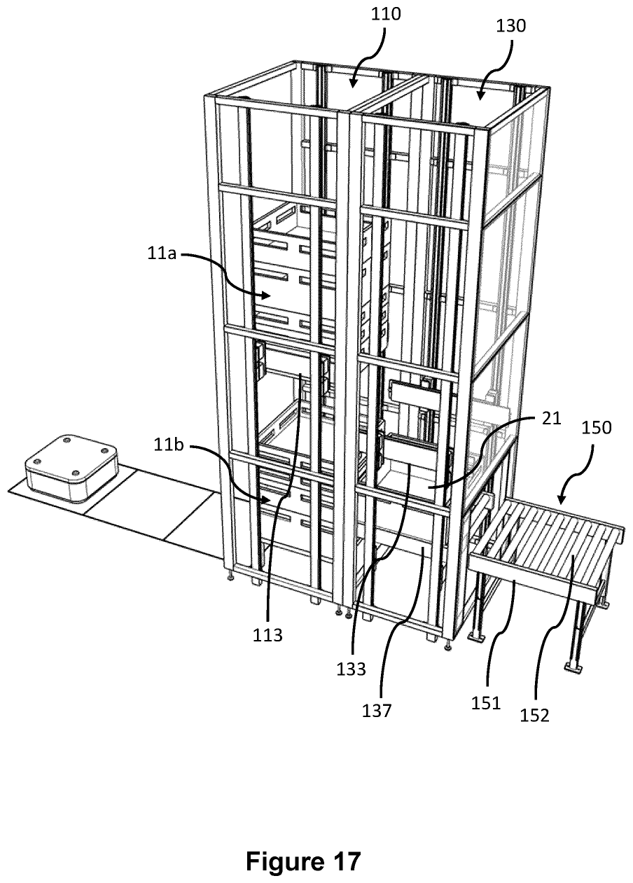

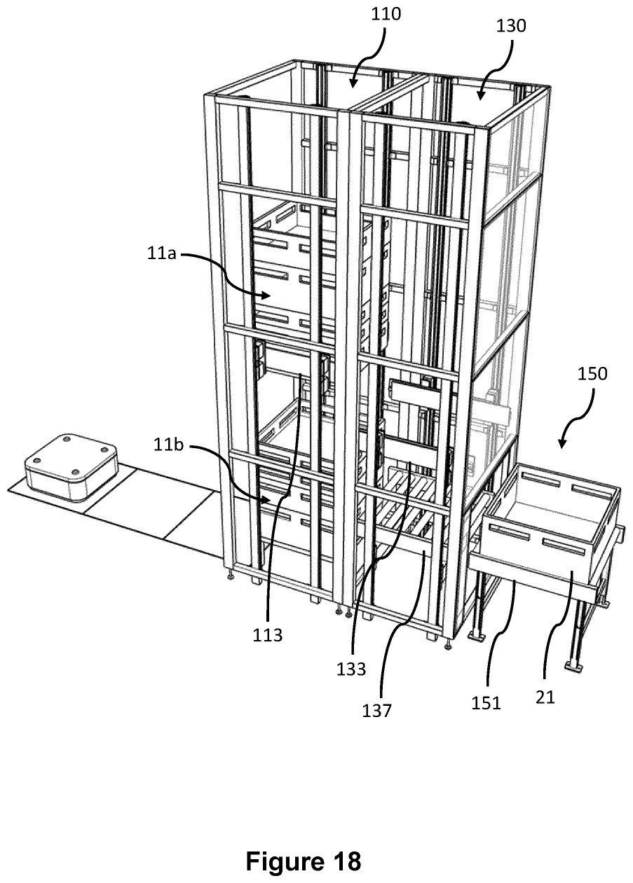

As shown in FIG. 17, once the receiving conveyor 137 has received the target container 21, the receiving conveyor 137 moves vertically to the port surface 152. Once the receiving conveyor 137 has aligned itself with the port surface 152, the receiving conveyor 137 can convey the target container 21 onto the port surface 152, as shown in FIG. 18. From the port surface 152, the target container 21 can then be transported to another destination, e.g. by a conveyor, a human, a vehicle, etc.

Although the container receiving surface 137 described above is vertically moveable within the container receiving region 130, the vertical position of the container receiving surface 137 may instead be fixed (e.g. at the same vertical position as the port surface 152), and the handling member 133 may be configured to move vertically towards the container receiving surface 137 before releasing the target container 21. However, in FIGS. 9-18, it can be seen that the bottom of the stack 10 is lower than the fixed port surface 152. Therefore, providing a container receiving surface 137 that is vertically moveable within the container receiving region 130 (in particular moveable below the bottom-most container in the stack 10) allows the handling members 133 to extract any of the containers below the port surface 152 and allows these containers to be lifted to the port surface 152. In alternative examples, the stack of containers 10 may be received at the stack processing apparatus 100 such that the bottom of the stack 10 is at the same height or higher than the port surface 152. In these cases, the container receiving surface 137 does not need to move vertically to allow the handling members 133 to access the containers 20 at the bottom of the stack 10.

The stack processing apparatus 100 can also function in a reverse manner to insert a free container into the stack. A free container 24 is defined as a container 20 that is to be inserted into a stack 10. Thus, a target container 21 that has been extracted from a stack 10 can be referred to as a free container 24 if it is to be reinserted into the stack 10, or inserted into a different stack 10. A free container 24 can also be a container 20 that has not previously been part of a stack 10. A free container 24 may arrive at the stack processing apparatus 100 at the container port 151.

Starting from the state of the stack processing apparatus 100 shown in FIG. 18, a number of different operations can now happen.

If another target container 21 is to be extracted from the same stack 10, and the next target container 21 happens to be the container that is now at the top of the lower sub-stack 11b, then the separating members 113 may remain in position, and the handling members 133 may move vertically and horizontally to extract the next target container 21 from the stack, in the manner already described above.

If the next target container 21 is located elsewhere in the same stack 10, then the separating members 113 may lower and release the upper sub-stack 11a onto the lower sub-stack 11b to reform the stack 10. The separating members 113 may then perform another separating operation to separate the stack 10 at the appropriate position to allow the handling members 113 to extract the next target container 21 in the manner already described above.

If a free container 24 is to be inserted into the same stack 10 in the same position that a target container 21 was just extracted from, then the separating members 113 may remain in position while a free container 24 arrives at the container port 151 and is moved onto the receiving conveyor 137 in the container receiving region 130. The handling members 113 can then move vertically to the free container 24 to engage it, or the receiving conveyor 137 can move vertically to lift the free container 24 towards the handling members 133 so that the handling members 133 can engage the free container 24. The handling members 133 can then horizontally move the free container 24 into the gap between the upper sub-stack 11a and the lower sub-stack 11b and release the free container 24 on top of the lower sub-stack 11b. The separating members 113 can then lower and release the upper sub-stack 11a onto the top of the inserted free container 24 to reform the stack 10.

If a free container 24 is to be inserted into the same stack 10 but in a different position to the position that a target container 21 was just extracted from, then the separating members 113 may first lower and release the upper sub-stack 11a onto the lower sub-stack 11b to reform the stack 10. The separating members 113 may then perform another separating operation to separate the stack 10 at an appropriate position to allow the handling members 113 to insert the free container 24 into the desired position in the stack 10.

Containers 20 may be extracted from and/or inserted into the same stack 10 at various different positions in the manner described above until no more operations on the stack 10 are required. The separating members 113 can then reform the stack 10, which can then be transported away from the stack receiving region 110 to a different location. A different vertical stack of containers 10 can then be transported into the stack receiving region 110 for container extraction and/or insertion.

The stack processing apparatus 110 may be configured to just extract target containers 21, to just insert free containers 24, or to perform both extraction and insertion operations.

It will be appreciated that if a target container 21 is at the top of the stack 10, then the stack does not need to be separated before the handling members 113 extract the target container 21. Similarly, the stack 10 does not need to be separated if a free container 24 is to be inserted onto the top of the stack 10 or at the bottom of the stack 10 (though in the latter case, the whole stack 10 will need to be lifted by the separating members 113).

Various modifications to the stack processing apparatus 100 illustrated in FIGS. 9-18 will be apparent to the skilled person.

For example, the container port region 150 horizontally adjacent to the container receiving region 130 is optional. Instead of providing a container port region 150, the target container 21 may be directly removed from the container receiving surface 137 in the container receiving region 130 (e.g. by a human or a vehicle), or the container receiving surface 137 may be part of a vehicle which directly receives the target container 21 from the handling members 137 and transports it to a different location.

Providing a container receiving surface 137 within the container receiving region 130 is also optional. For example, the handling members 133 may be configured to directly place and release the target container 24 onto the port surface 152 of the container port 151. This may be achieved by providing handling members 133 that are horizontally moveable between the stack receiving region 110, the container receiving region 130 and the container port region 150. For example, the handling members 133 may comprise retractable arms 136 configured to extend from the container receiving region 130 to the stack receiving region 110 and from the container receiving region 130 to the container port region 150.

The handling members 133 may be vertically moveable within the stack receiving region 110 instead of the container receiving region 130. In this variation, the handling members 133 may be vertically moveable within the stack receiving region 110 independently of the separating members 113. To horizontally extract the target container 21, the handling members 133 may comprise retractable arms 136 that extend horizontally from the stack receiving region 110 to the container receiving region 130.

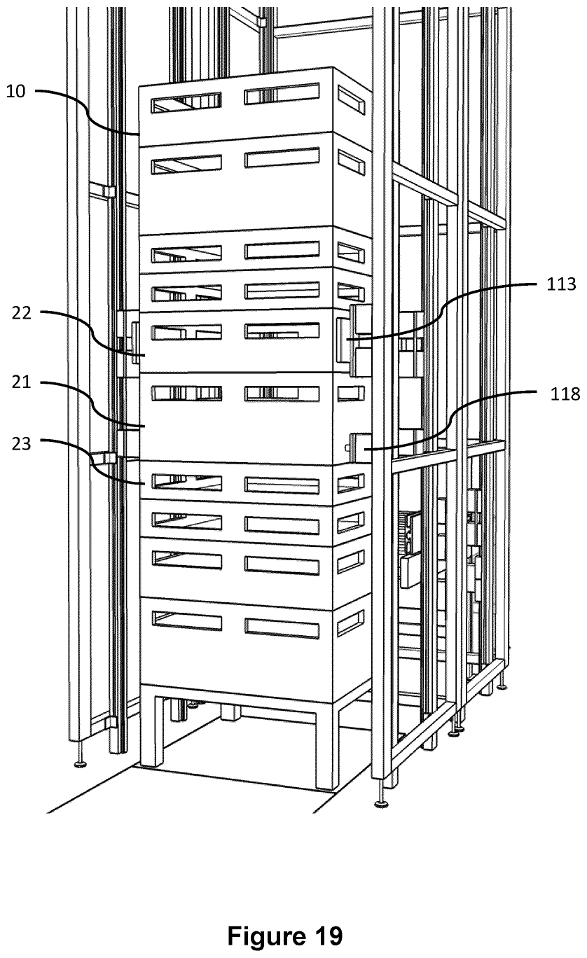

FIG. 19 shows a view of the stack receiving region 110 of the stack processing apparatus 100 in which the stack separating mechanism 112 further comprises a supporting member 118 vertically moveable within the stack receiving region 110 independently of the separating members 113. The supporting member 118 is configured to releasably engage a container in the stack using similar engaging features 119 as already described for the separating members 113 and the handling members 133.

Similar to the separating members 113 and the handling members 133, an opposing pair of separating members 118 can be provided. The supporting members 113 may be moveable on the same vertical rails 115 as the separating members 113, or different vertical rails, or partially shared rails.

One purpose of the supporting members 118 is to support the containers below the target container 21 so that when the target container 21 is being extracted by the handling members 133, the containers below the target container 21 are prevented from being inadvertently lifted or moved with the target container 21. To do this, the supporting members 118 are configured to vertically move to and engage the container 23 immediately below the target container 21 and hold the container 23 in position while the handling members 133 extract the target container 21.

Alternatively or additionally, the supporting members 118 may support the lower sub-stack 11b when the separating members 113 are lifting the upper sub-stack 11a so that no containers from the lower sub-stack 11b are inadvertently lifted with the upper sub-stack 11a. To do this, the supporting members 118 are configured to vertically move to and engage the target container 21 and hold the target container 21 in position while the separating members 113 separate the stack 10. Once the stack 10 is separated, the supporting members 118 may then move vertically down to and engage the container 23 immediately below the target container 21 (as described above) to support the containers below the target container 21 while the handling members 133 extract the target container 21.

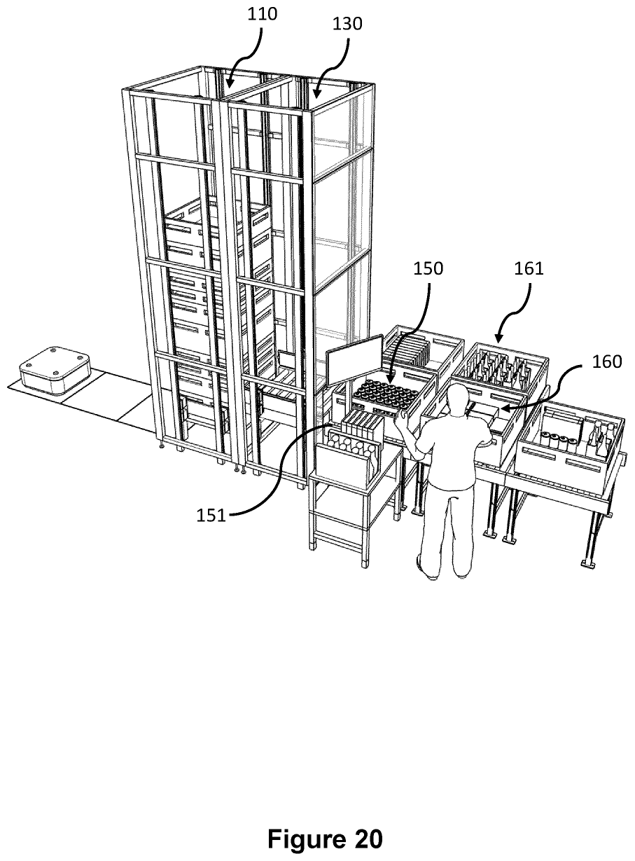

FIG. 20 shows the stack processing apparatus 100 further comprising a container processing region 160 configured to receive extracted target containers 21 from the container port 151. At the container processing region 160, a target container may undergo processing, e.g. items may be placed into or taken out of the target container by a human or robotic device. The stack processing apparatus 100 may also comprise a buffer region 161 in which previously or subsequently extracted target containers 21 may be temporarily stored without blocking the container processing region 160. Containers may move between the container port 151, the container processing region 160 and the buffer region 161 using an arrangement of conveyors or other transporting means.

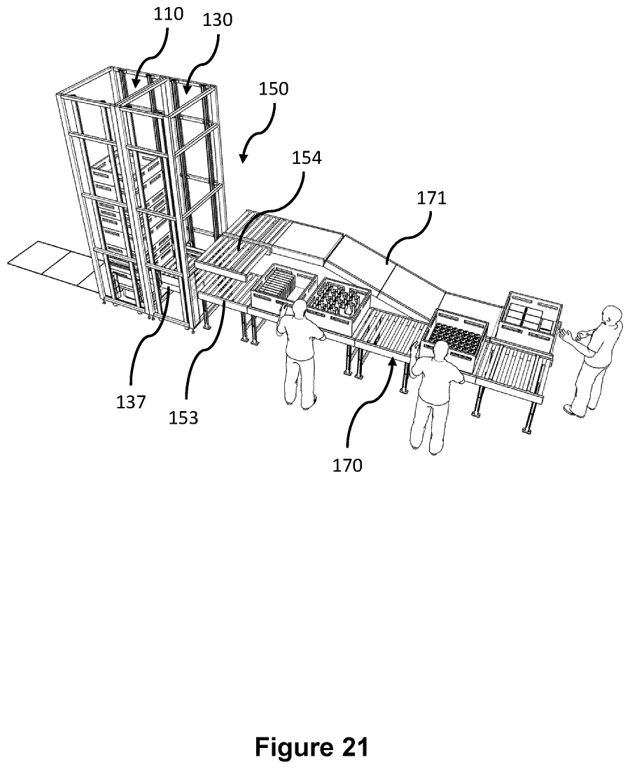

FIG. 21 shows the stack processing apparatus 100 where the container port region 150 comprises two container ports 151—an out-feed port 153 configured to receive an extracted target container 21 from the container receiving region 130 and an in-feed port 154 configured to receive a free container 24 to be moved into the container receiving region 130 for insertion into the stack 10. The out-feed port 153 is located vertically below the in-feed port 154 so that target containers 21 can exit the container receiving region 130 at one vertical level and free containers 24 can enter the container receiving region 130 at another vertical level.

In this arrangement, the container receiving surface 137 in the form of a receiving conveyor is vertically moveable within the container receiving region 130 between at least the out-feed port 153 and the in-feed port 154 to allow target containers 21 received from the handling members 133 to be moved to the out-feed port 153 and to allow free containers 24 received at the in-feed port 154 to be moved onto the container receiving surface 137.

In this arrangement, the out-feed port 153 and in-feed port 154 are connected by a container path 170 external to the container receiving region 130 that allows a target container 21 to travel from the out-feed port 153 to the in-feed port 154. In this way, a target container 21 may be extracted from the stack 10 to the out-feed port 153 and travel along the container path 170 where it may undergo processing (e.g. items may be taken out of, or placed into, the target container 21), before arriving at the in-feed port 154 where the target container 21 (now free container 24) can be re-inserted into the same stack 10 or inserted into a different stack 10 that has arrived in the stack receiving region 110. The container path 170 may comprise a continuous path that allows a container 20 to travel from the out-feed port 153 to the in-feed port 154 uninterrupted, although in use, the container 20 may stop at one or more locations along the container path 170 for processing (e.g. items may be placed into and/or taken out of the container 20). One or more container processing regions 160 and/or one or more buffer regions 161 (not shown) may be located on the container path 170, as described above in relation to FIG. 20. The container path 170 may be configured to automatically transport containers 20 along it; for example, the container path 170 may take the form of a conveyor.

To allow the target container 21 to travel the vertical distance between the out-feed port 153 and the in-feed port 154, the container path 170 comprises vertical transportation means 171 in the form of an inclined conveyor. However, other vertical transportation means 171 such as a lifting mechanism (e.g. in the form of a vertically moveable section of conveyor) may be used instead.

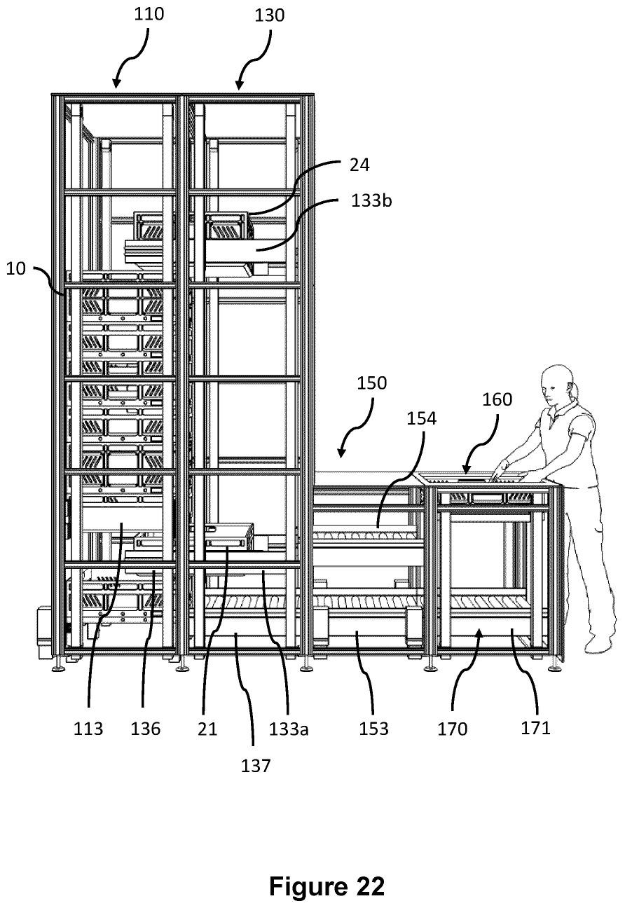

FIG. 22 shows the stack processing apparatus 100 where the container port region 150 comprises an out-feed port 153 located vertically below an in-feed port 154. In this arrangement, the container receiving surface 137 is not configured to move vertically within the container receiving region 130 but is instead fixed at the same vertical position as the port surface 152 of the out-feed port 153. In order to efficiently transport containers 20 from the container receiving region 130 to the out-feed port, and to the container receiving region 130 from in-feed port 154, the container handling mechanism 131 comprises two pairs of vertically arranged handling members 133a, 133b that are vertically movable within the container receiving region independently of each other. The two pairs of handling members 133a, 133b may move vertically on shared vertical rails or on different vertical rails. One pair of handling members, hereby referred to as the “extracting pair” 133a, is configured to extract target containers 21 from the stack 10 and transfer them to the container receiving surface 137 for transport to the out-feed port 153. The other pair of handling members, hereby referred to as the “inserting pair” 133b, is configured to engage free containers 24 from the in-feed port 154 and insert them into the stack 10. To avoid conflict between the extracting pair 133a and the inserting pair 133b, the inserting pair 133b is located above the extracting pair 133a. To allow the inserting pair 133b to engage free containers 24 from the in-feed port 153, at least a portion of the inserting pair 133b is further horizontally movable between the container receiving region 130 and the container port region 150. For example, the inserting pair 133b may comprise a retractable arm 136 configured to extend in the direction of the container port region 150 as well as in the direction of the stack receiving region 110.

Providing two pairs of handling members 133a, 133b, one for extraction and one for insertion, is not essential and one pair of handling members 133 can perform both tasks instead, albeit less efficiently. Providing two pairs of handling members 133a, 133b also provides redundancy in case one pair malfunctions. Furthermore, the container receiving surface 137 does not need to be vertically fixed and may instead move vertically within the container receiving region 130, similar to the arrangement of FIG. 21.

The container receiving surface 137 is also optional and at least a portion of the extracting pair of handling members 133a may be configured to move between the container receiving region 130 and the container port region 150 to directly move the target container to the out-feed port 153.

Similar to the arrangement of FIG. 21, the arrangement of FIG. 22 comprises a container path 170 external to the container receiving region 130 that connects the out-feed port 153 to the in-feed port 154. The container path 170 comprises vertical transportation means 171 in the form of a lifting mechanism that lifts a container from the height of the out-feed port 153 to the height of the in-feed port 154. The lifting mechanism 171 may take the form of a vertically movable conveyor section, for example. The lifting mechanism 171 may be configured to lift the containers to a height that is convenient for a human operator to access the contents of the container (e.g. to take items out of or place items into the container). If the stack 10 comprises containers 20 of different height dimensions, then the lifting mechanism 171 may be configured to raise the top of each container to the same vertical position, regardless of the height dimension of the container, so that each container is at a consistent vertical position for access by a human operator or other device.

Although in the arrangements of FIG. 21 and FIG. 22 the container port region 150 comprises an out-feed port 153 located vertically below an in-feed port 154, the container port region 150 may comprise other arrangements of container ports 151. For example an in-feed port 154 may be located vertically below an out-feed port 153. In general, the container port region 150 may comprise a single container port 151, or a plurality of container ports 151 arranged vertically or arranged in a horizontal plane about the container receiving region. When arranged vertically, the container ports 151 may be arranged directly above or below each other, or the container ports 151 may be horizontally offset from each other. The container port region 150 may comprise a single out-feed port 153 and/or a single in-feed port 154. The container port region may comprise a single out-feed port 153 with a plurality of in-feed ports 154, or a plurality of out-feed ports 153 with a single in-feed port 154, or a plurality of out-feed ports 153 and a plurality of in-feed ports 154. Each out-feed port 153 may be configured to transport a target container 21 to a different location. Each in-feed port 154 may receive a free container 24 from a different location. In arrangements where the container ports 151 are arranged in a horizontal plane about the container receiving region, the container receiving surface 137 in the container receiving region 130 may be configured to rotate about a vertical axis to align itself with each container port 151, or the container receiving surface 137 may be capable of conveying a container in any one of a plurality of different directions (e.g. perpendicular directions).

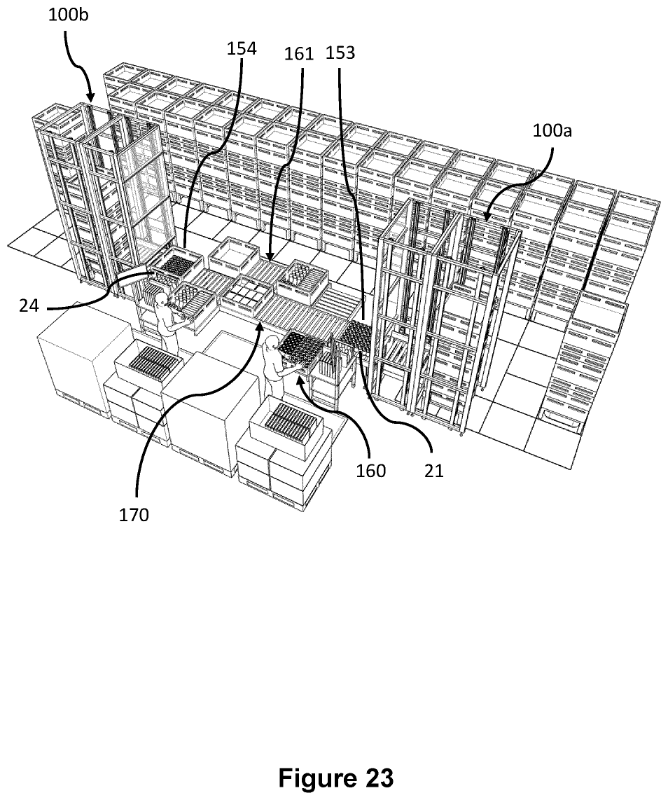

FIG. 23 shows an arrangement where two stack processing apparatuses 100 are operationally connected together. In particular, a first stack processing apparatus 100a is configured to extract target containers 21 from a stack 10 and comprises an out-feed port 153. A second stack processing apparatus 100b is configured to insert free containers 24 into a stack 10 and comprises an in-feed port 154. The out-feed port 153 of the first stack processing apparatus 100a is connected to the in-feed port 154 of the second stacking processing apparatus 100b by a container path 170 (e.g. a conveyor) so that target containers 21 extracted in the first stack processing apparatus 100a can be fed as free containers 24 into the second stacking apparatus 100b.

Containers may undergo processing as they travel along the container path 170. For example, items may be taken out of or inserted into the containers by humans or robotic devices. The container path 170 may comprise one or more container processing regions 160 at which a container can stop to allow items to be taken out of or placed into the container. The container path 170 may comprise one or more buffer regions 161 for temporarily storing containers without blocking the path between the two stack processing apparatuses 100a, 100b.

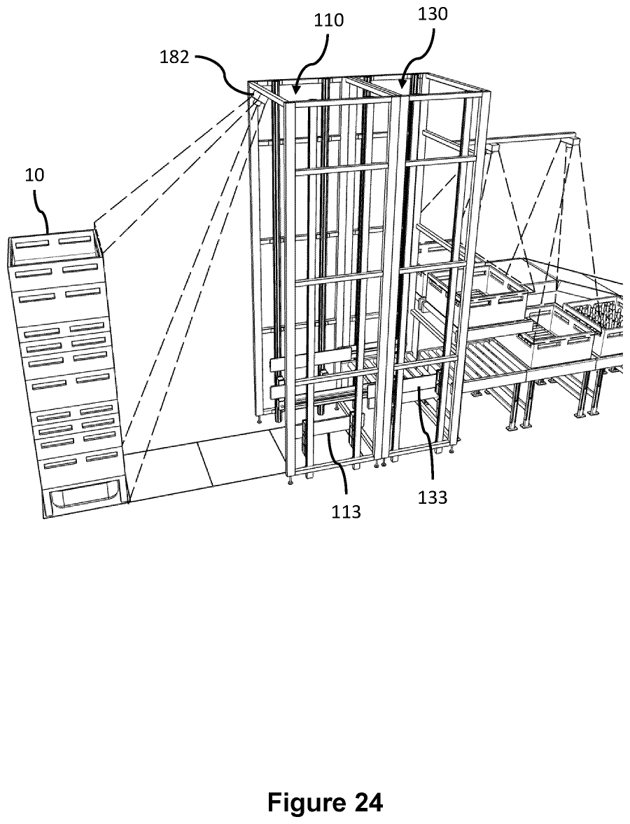

FIG. 24 shows the stack processing apparatus 100 further comprising a first container recognition system 181 configured to determine the vertical position of one or more containers within the stack 10. The container recognition system 181 may be part of a control system 180 for controlling the vertical movement of the separating members 113 and handling members 133.

In this example, the container recognition system 181 is in the form of a vision system 181. The vision system 181 comprises a camera 182 configured to capture one or more images of the stack of containers 10 as the stack 10 approaches the stack receiving region 110. One or more processors are then configured to analyse the images of the stack 10 to determine the vertical positions of one or more containers 20 in the stack 10 so that the one or more processors of the control system 180 can command the separating members 113 and handling members 133 to vertically move to the appropriate vertical positions to allow the stack 10 to be separated at the correct position and the target container 21 to be extracted.

For example, each container 20 may comprise a visual identifier (e.g. a barcode or QR code) that can be recognised by the vision system 181. Furthermore, the control system 180 may comprise a data store comprising data associating the visual identifier of a container 20 with the height dimension of the container 20. Thus, by recognising each container 20 in the stack and using the data relating to their height dimensions, the control system 180 can determine the vertical distances that the separating members 113 and the handling members 133 need to travel to perform their respective functions.

Alternatively, the one or more processors of the vision system 181 may be configured to perform image processing and image analysis techniques such as edge detection to determine the vertical positions of one or more containers 20 in the stack 10.

Instead, of capturing images of the stack 10 as it approaches the stack receiving region 110, the camera 182 may be configured to capture one or more images of the stack 10 when it is in the stack receiving region 110.

Instead of capturing images of the whole stack 10, the camera 182 may be configured move vertically within the stack receiving region 110 and capture images of the side of the containers as the camera 182 travels up or down the stack 10. The camera 182 may move vertically with the separating members 113 or independently of the separating members 113. Once the one or more processors recognises the target container 21 (via visual its identifier as described above), then the control system 180 can move the separating members 113 and handling members 133 accordingly to perform their respective functions.

The container recognition system 181 may alternatively be in the form of an RFID system wherein each container 20 comprises an RFID tag and the control system 180 comprises an RFID reader. The RFID reader may be configured to read the RFID tags of the containers 20 in the stack 10 as the stack 10 approaches the stack receiving region 110, or the RFID reader may be configured to move vertically within the stack receiving region 110 and read the RFID tag of each container 20 as the RFID reader travels up or down the stack 10. The RFID reader may move vertically with the separating members 113 or independently of the separating members 113. Once the RFID reader recognises the target container 21, the control system 180 can move the separating members 113 and handling members 133 accordingly to perform their respective functions.

The container identifiers (e.g. barcode, QR code, RFID tag, etc.) may uniquely identify the container 20, or may identify the type of container 20 (e.g. the same identifier may be applied to all containers having particular dimensions).

If the containers 20 all have the same dimensions, then a container recognition system may not be necessary. In this case, the control system 180 only needs to know the relative position of the target container 21 within the stack (e.g. the third container from the bottom) and the predetermined height dimension of the containers 20 in order to move the separating members 113 and handling members 133 to the appropriate vertical positions to extract the target container 21.

FIG. 24 also shows a second container recognition system 185 at the container port region 150 configured to recognise containers entering the container ports 151. In particular, the container recognition system 185 comprises an out-feed camera 186 configured to recognise target containers entering the out-feed port 153 and an in-feed camera 187 configured to recognise target containers entering the in-feed port 154. The out-feed camera 186 and in-feed camera 187 may be configured to recognise containers in the same way as the first container recognition system 181 described above (i.e. via identifiers on each container). The second container recognition system 185 allows the control system 180 to double check that the correct target container 21 has been extracted from the stack 10 and double check the free container 24 that is to be inserted into the stack. The second container recognition system 185 may also be configured to check the contents of each container as they enter the container ports 151 (e.g. using image recognition techniques).

Similar to the first container recognition system 181, the second container recognition system 185 can use alternative methods of recognising containers, e.g. RFID tags and readers. The second container recognition system 185 can also be located at the container receiving region instead of the container port region for recognising containers entering the container-receiving region.

The container recognition systems 181, 185 are not limited for use on the stack processing apparatus 100 and may be used on any of the stack processing apparatuses described herein.

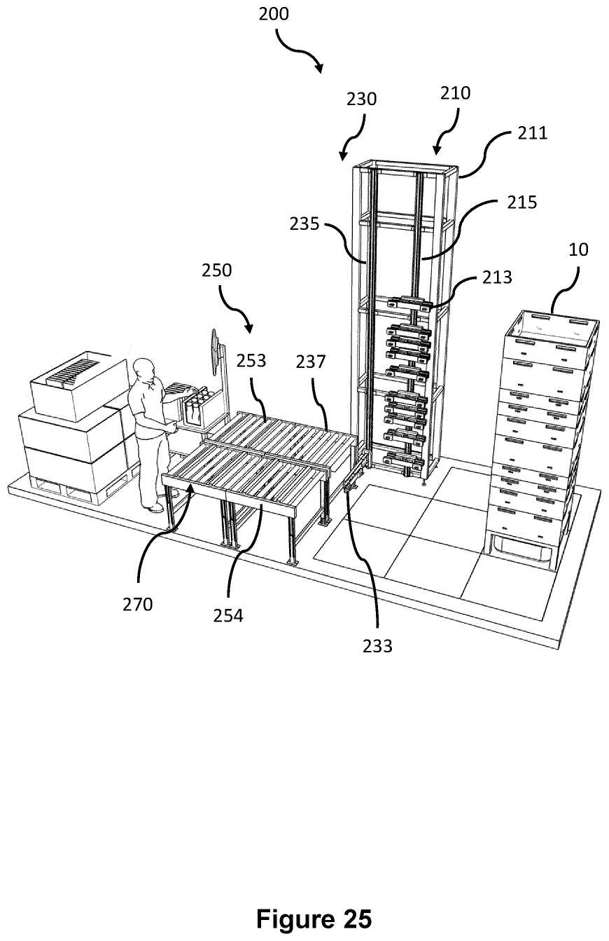

FIG. 25 shows a stack processing apparatus 200 that functions similarly to the stack processing apparatus 100 of FIGS. 9-18 in that it is able to extract a target container 21 from a vertical stack of containers 10 and/or insert a free container 24 into a vertical stack of containers 10. However, instead of separating the stack 10 into two sub-stacks 11 (an upper sub-stack and a lower sub-stack), the stack processing apparatus shown in FIG. 25 is able to separate the stack into more than two sub-stacks. By separating the stack 10 into more than two sub-stacks, more than one target container 24 may be extracted from the separated stack 10 and/or more than one free container 24 may be inserted into the separated stack 10 without having to reform the stack 10 in between each extraction or insertion operation.

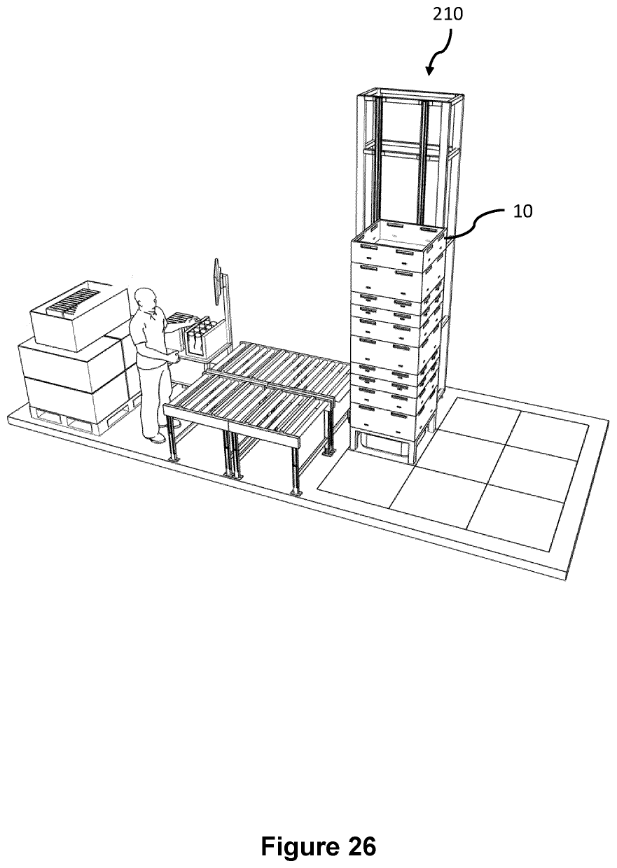

Similar to stack processing apparatus 100, stack processing apparatus 200 comprises a stack receiving region 210 for receiving a vertical stack of containers 10. In contrast to stack processing apparatus 100, the stack receiving region 210 is not defined within a columnar frame structure but is instead partially defined by a frame structure 211 located at one side of the stack receiving region 210. FIG. 26 shows a vertical stack of containers 10 inside the stack receiving region 210 with the frame structure 211 located on one side of the stack 10.

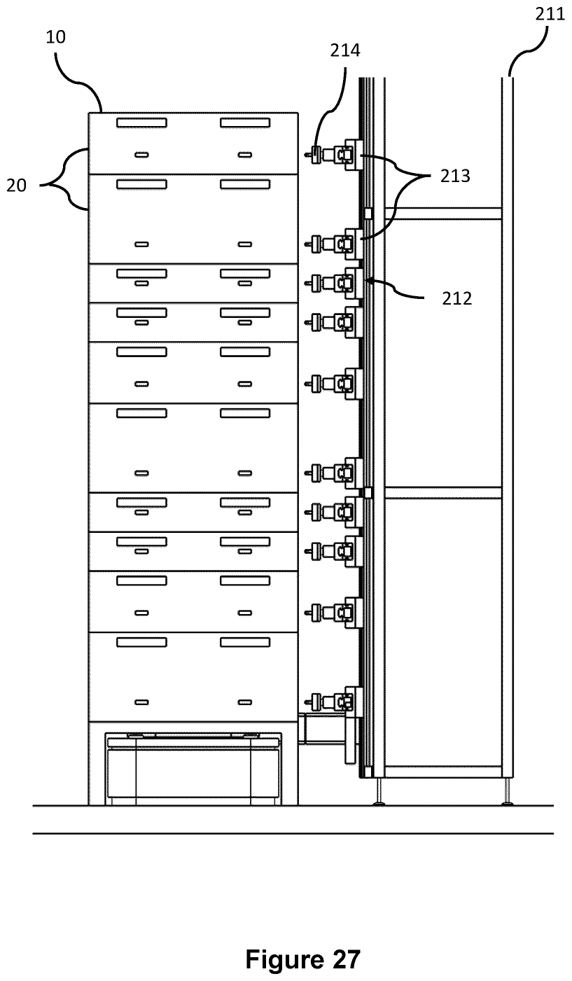

FIG. 27 shows a side view of the stack 10 and the frame structure 211. The stack receiving region 210 comprises a stack separating mechanism 212 comprising a plurality of vertically arranged separating members 213 that are vertically moveable within the stack receiving region 210 independently of each other. The separating members 213 are moveable on a vertical rail 215 (visible in FIG. 25) supported by the frame structure 211. The separating members 213 may be vertically moveable on the rail 215 independently of each other using known mechanisms. For example, the vertical rail 215 may be static and each separating member 213 may comprise a motor configured to move the separating member 213 along the rail 215. The vertical rail 215 may comprise an electric wire in contact with the separating members 213 for delivering power to the motors.

Similar to the stack processing apparatus 100, each separating member 213 is configured to releasably engage a container 20 in the stack 10. The separating members 213 may comprise any suitable mechanism for engaging a feature on the container 20, as already described in relation to the stack processing apparatus 100.

Although in this example the separating members 213 are only provided on one side of the stack receiving region 210, the separating members 213 may also be arranged in opposing pairs, similar to the stack processing apparatus 100.

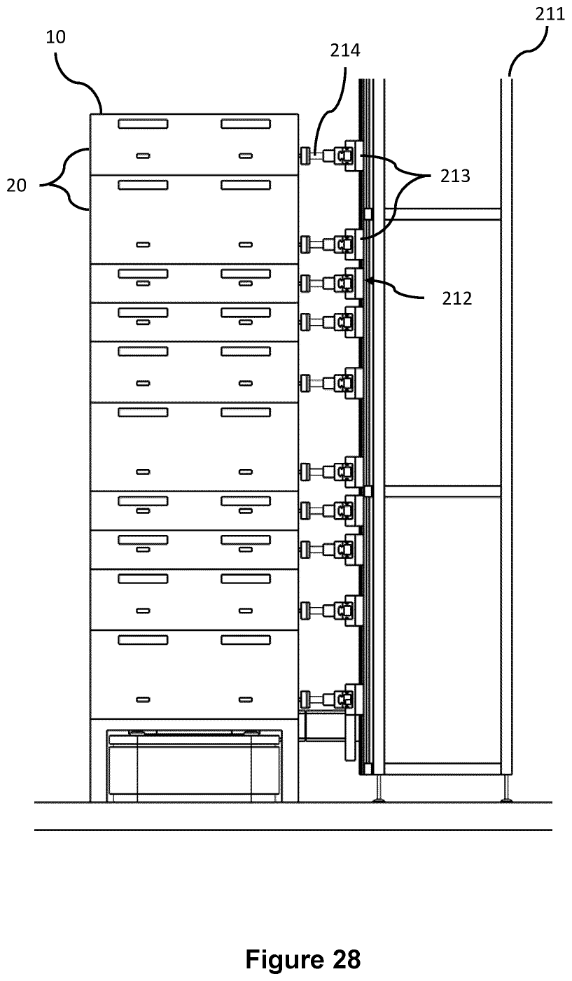

FIGS. 27 and 28 show the separating members 213 moving from a released position to an engaged position to engage each container 20 in the stack 10. As shown in these figures, the stack receiving region 210 comprises enough separating members 213 to engage every container 20 in the stack 210. The number of separating members 213 preferably corresponds to at least the maximum number of stacked containers 20 that the stack processing apparatus 200 is designed to receive and process.

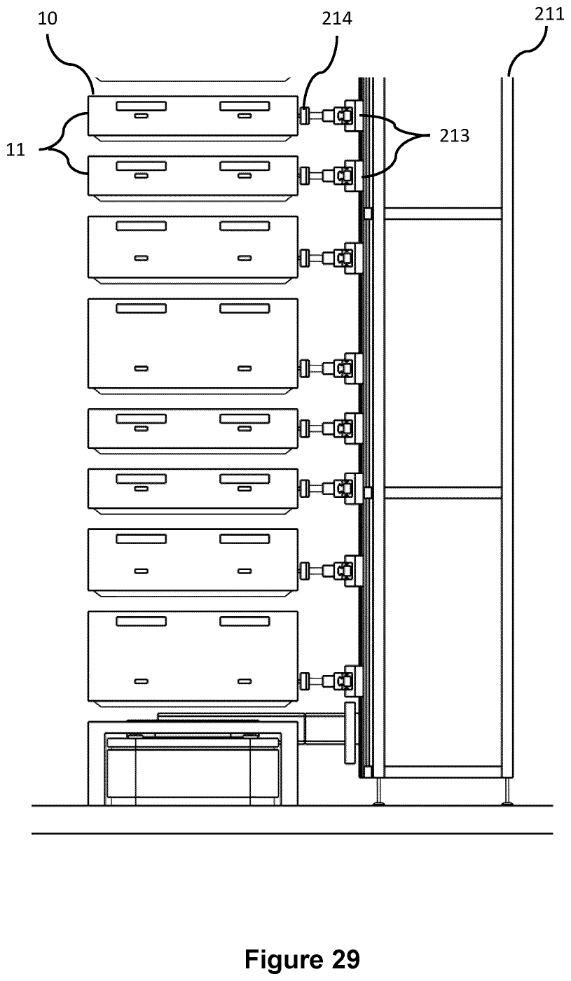

As shown in FIG. 29, once the separating members 213 have engaged every container 20 in the stack 10, the separating members 213 vertically lift every container 20 relative to each other so each individual container 20 is vertically spaced from the container 20 immediately above and below it. The stack 10 can now be considered to have been separated into a plurality of sub-stacks 11, with each sub-stack 11 containing only one container 20.

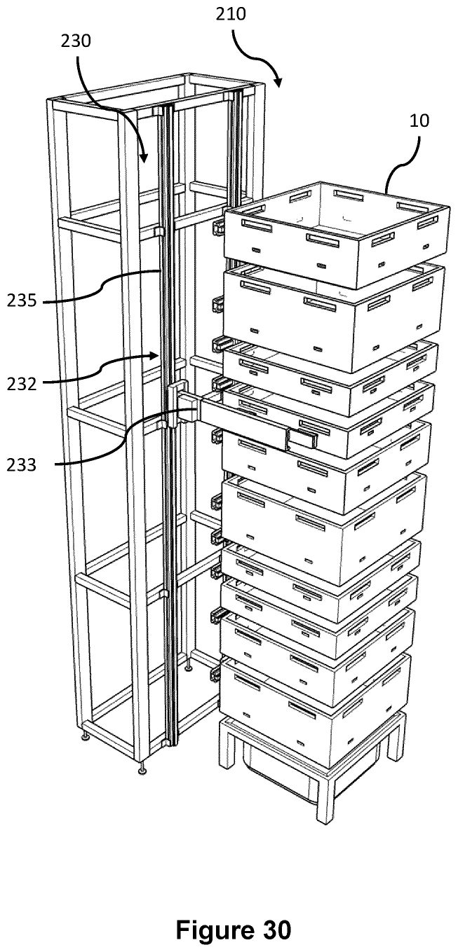

Similar to the stack processing apparatus 100, the stack processing apparatus 200 comprises a container receiving region 230 comprising a handling member 233, as shown in FIG. 30. In contrast to the container receiving region 130 of stack processing apparatus 100, the container receiving region 230 is not defined by a frame structure, but can be considered as a region horizontally adjacent to the stack receiving region 210 into which a target container 21 is extracted.

The handling member 233 is vertically movable to allow the handling member 233 to reach the vertical position of any container 20 in the stack 10 after separation. The handling member 233 is vertically movable on a vertical rail 235 supported by frame structure 215. The handling member 233 may move on the vertical rail 235 using known means, as already described in relation to the handling member 133 of stack processing apparatus 100.

Similar to the handling members 133 of the stack processing apparatus 100, the handling member 233 is configured to releasably engage the target container 21 in the separated stack and may comprise any suitable mechanism for engaging a feature on the target container 21, as already described in relation to handling members 133.

As shown in FIG. 30, the separating members 213 are located on one side of the stack receiving region 210 for engaging one side of the containers 20 in the stack 10, and the handling member 233 extends along an adjacent side of the stack receiving region 210 for engaging an adjacent side of the containers 20 in the stack 10.

Once the handling member 233 has vertically moved to the vertical position of the target container 21 and engaged it, the separating member 213 that is engaging the target container 21 is configured to release the target container 21.

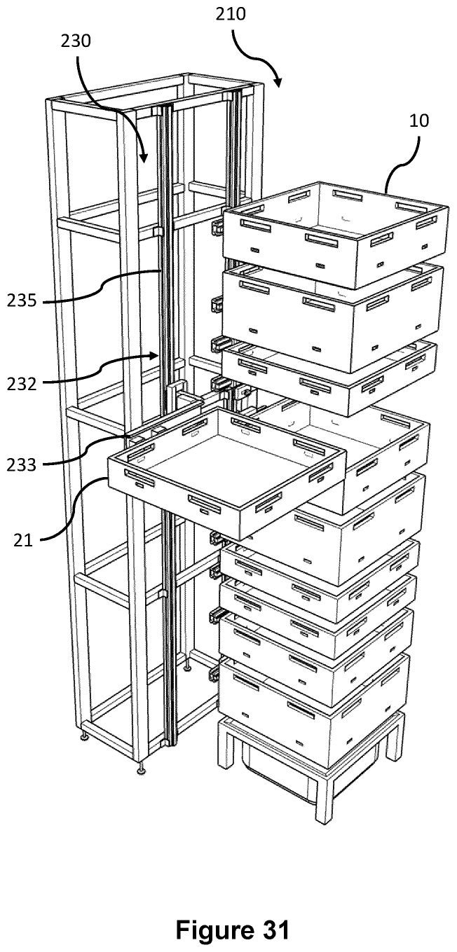

At least a portion of the handling member 233 is horizontally moveable toward and away from the stack receiving region 210 to allow the handling member 233 to horizontally extract the target container 21 out of the stack 10. As shown in FIG. 30 and FIG. 31, the handling member 233 is pivotally mounted for horizontal movement about a vertical axis, in contrast to the linear horizontal movement of the handling members 133 of stack processing apparatus 100. In this example, the handling member 233 is pivotally movable through 90 degrees so that once the handling member 233 has engaged the target container 21 (and the separating member 213 has released the target container 21), the pivotal movement of the handling member 233 causes the target container 21 to pivot out of the stack 10 along a horizontal plane into the container receiving region 230.

Once the target container 21 has been extracted out of the stack 10, the handling member 233 is then configured to move vertically to place and release the target container 21 onto a container receiving surface 237 located in the container receiving region 230. In this example, the container receiving surface 237 is in the form of a receiving conveyor 237 (visible in FIG. 25). The receiving conveyor 237 is at a fixed vertical position, but as described in relation to the container receiving surface 137 of stack processing apparatus 100, the container receiving surface 237 could also be configured to move vertically within the container receiving region 230.

Similar to the stack processing apparatus 100, the stack processing apparatus 200 can be considered as having a container port region 250 horizontally adjacent to the container receiving region 230. As shown in FIG. 25, the container port region 250 comprises an out-feed port 253 configured to receive a target container 21 from the container receiving region 230 and an in-feed port 254 configured to receive a free container 24 to be moved into the container receiving region 230. In this example, the out-feed port 253 and the in-feed port 254 are arranged in a horizontal plane about the container receiving region 230. The out-feed port 253 is connected to the in-feed port 254 by a container path 270 external to the container receiving region 230 along which the target container 21 can travel from the out-feed port 253 to the in-feed port 254 for re-insertion into the same stack 10 or a different stack 10. In this example, the container path 270 is in the form of a conveyor 270. The target container 21 may undergo processing while travelling along the container path 270, e.g. items may be placed into or taken out of the target container, and the container path 270 may comprise container processing regions and/or buffer regions, as already described above in relation to container path 170.

While the stack 10 is separated, the handling member 233 may extract multiple target containers 21 in succession using the same process described above.

The stack processing apparatus 200 may also function in a reverse manner to insert a free container 24 into any position in the stack 10. In particular, once a target container 21 has been extracted from the stack 10, the separating members 213 may be held in position while the handling member 233 engages a free container 24 received in the container receiving region 230. The handling member 233 can then insert the free container 24 into the space left by the extracted target container 21, and the separating member 213 that was previously engaging the extracted target container 21 can now engage the inserted free container 24. The handling member 213 can then release the free container 24 and the separating members 213 can vertically move together to reform the stack 10.

If the free container 24 has a different height dimension to the extracted target container 21, then the separating members 213 may adjust their vertical positions to provide an appropriately sized space for the free container 24 to be inserted.

The free container 24 does not necessarily need to be engaged by a separating member 213 after it is inserted into the stack. Instead, the free container 24 may be placed on top of a container 20 in the stack 10, provided that each separating member 213 is strong enough to hold the weight of more than one container 20.

If multiple target containers 21 have been extracted from the stack 10, then multiple free containers 24 can be inserted into the spaces left by the extracted target containers 21 before the stack 10 is reformed.

Although in this example the stack separating mechanism 212 comprises enough separating members 213 to engage and lift every container in the stack, this is not essential and the stack separating mechanism 212 may comprise at least two separating members 213 to separate the stack 10 into more than two sub-stacks 11 containing one or more containers 20.

It will be appreciated that features of the stack processing apparatus 200 can be combined with features of the stack processing apparatus 100 and vice versa. For example, the features of the stack receiving regions 110, 210, the container receiving regions 130, 230, the container port regions 150, 250 and the container paths 170, 270 described in relation to stack processing apparatuses 100, 200 are not intended to be specific to those stack processing apparatuses but instead can be combined in any combination to form a stack processing apparatus suitable for extracting containers out of and/or inserting containers into a stack.

One or more stack processing apparatuses 100, 200 may form part of a wider storage and retrieval system, such as the system described in relation to FIGS. 6 to 8, in which items are stored in containers arranged into vertical stacks 10. The storage and retrieval system may comprise a picking station at which items are removed from individual containers, e.g. to fulfil a customer order. The picking station may comprise a stack processing apparatus 100, 200 configured to extract target containers from a stack 10 so that the items in the target containers can be removed. The stack processing apparatus 100, 200 can also be configured to return extracted containers to a stack. The arrangements shown in FIGS. 20-23 may be used as picking stations, for example. The storage and retrieval system may also comprise a filling station at which empty containers are filled with items to be stored. The filling station may comprise a stack processing apparatus 100, 200 configured to insert the filled containers into an existing stack 10 or form a new stack 10. The stacks 10 within the system may be in the form of stack units 40 as described above, and the storage and retrieval system may further comprise one or more vehicles 50, as described above.

1.-45. (canceled)

46. A storage and retrieval system comprising:
one or more stack units, each stack unit including:
a stand including a stand top and one or more legs extending downwardly from the stand top; and
one or more containers located on the stand top;
the storage and retrieval system including one or more vehicles dimensioned to allow vehicle movement underneath the stand top, each vehicle including a lifting mechanism configured to be moveable between a raised position and a lowered position to raise the stack unit off the ground and lower the stack unit onto the ground respectively.

47. The storage and retrieval system of claim 46, wherein each stack unit comprises:
a plurality of containers directly stacked on top of each other to form a vertical stack located on the stand top.

48. The storage and retrieval system of claim 47, wherein the containers are configured and reversibly stacked on top of each other; and optionally:
wherein each container includes one or more interlocking features configured to reversibly interlock with one or more corresponding interlocking features of adjacent containers in the vertical stack.

49. The storage and retrieval system of claim 46, wherein each container is configured to be removably receivable on the stand top; and optionally:
wherein each container includes one or more interlocking features configured to reversibly interlock with one or more corresponding interlocking features on the stand top.

50. The storage and retrieval system of claim 46, wherein the stand top comprises:
one or more locating features configured to cooperate with one or more corresponding locating features on the one or more containers configured to help locate the container into a particular position on the stand top.

51. The storage and retrieval system of claim 46, wherein a footprint of each container is substantially a same as a footprint of the stand.

52. The storage and retrieval system of claim 46, wherein each vehicle is an automated or autonomous vehicle.

53. The storage and retrieval system of claim 46, wherein the lifting mechanism comprises:
a lifting surface moveable relative to a rest of the vehicle between the raised position and the lowered position such that the lifting surface is engaged with the stand top when the lifting surface is in the raised position and disengaged from the stand top when the lifting surface is in the lowered position; and optionally:
wherein the lifting surface includes one or more interlocking features configured to reversibly interlock with one or more corresponding interlocking features on the stand top when the lifting mechanism is in the raised position.

54. The storage and retrieval system of claim 46, wherein the stand top and the one or more legs define a space underneath the stand top and one or more side openings configured for allowing each vehicle to enter and exit the space; and optionally:
wherein the stand top and the one or more legs define a pair of opposing side openings; and optionally
wherein the stand includes two pairs of opposing side openings arranged orthogonally to each other.

55. The storage and retrieval system of claim 46, wherein each vehicle is dimensioned such that each vehicle will completely fit in the space underneath the stand top in a vertical direction.

56. The storage and retrieval system of claim 54, wherein each vehicle is dimensioned such that a lateral outer perimeter of the vehicle is fully contained within the space.

57. The storage and retrieval system of claim 46, comprising:
a plurality of stack units arranged in a grid pattern.

58. The storage and retrieval system of claim 46, comprising:
a storage area for storing the one or more stack units;
a picking station at which items are picked from one or more containers of a stack unit;
a filling station at which empty or partially full containers are filled with items and arranged to form new stack units or transferred onto existing stack units; and
a control system communicably coupled to the one or more vehicles and configured to control movement of the vehicles to transport stack units between the storage area, the picking station and the filling station; and optionally:
wherein the storage area includes a containing lifting device arranged above the stack units in the storage area, the containing lifting device being configured to transfer a container from the top of one of the stack units to the top of another stack unit.

59. A stack processing apparatus for moving a container out of and/or into a vertical stack of containers, the apparatus comprising:
a stack receiving region for receiving a vertical stack of containers;
a stack separating mechanism including a separating member configured to releasably engage a container in the stack, the separating member being vertically moveable within the stack receiving region and configured to allow the separating member to engage any container in the stack and vertically lift the engaged container to separate the stack into an upper sub-stack and a lower sub-stack to expose a target container at the top of the lower sub-stack; and
a container handling mechanism including a handling member configured to releasably engage the target container in the stack, the handling member being vertically moveable with respect to the stack receiving region and horizontally moveable to allow the handling member to engage and horizontally extract the target container out of the stack, and/or functioning in a reverse manner to insert a free container into the stack.

60. The stack processing apparatus of claim 59, wherein at least a portion of the handling member is linearly moveable in a horizontal direction towards and away from the stack receiving region.

61. The stack processing apparatus of claim 59, wherein the handling member comprises:
a retractable arm configured to linearly extend and retract in a horizontal direction towards and away from the stack receiving region.

62. The stack processing apparatus of claim 59, wherein at least a portion of the handling member is pivotally mounted for movement in a horizontal direction towards and away from the stack receiving region.

63. The stack processing apparatus of claim 59, wherein at least a portion of the separating member and/or at least a portion of the handling member is moveable towards and away from the stack to engage and release a container in the stack respectively.

64. The stack processing apparatus of claim 59, wherein the stack separating mechanism comprises:
a pair of horizontally opposed separating members configured to engage a container therebetween; and/or
the container handling mechanism includes a pair of horizontally opposed handling members configured to engage a container therebetween.

65. The stack processing apparatus of claim 59, comprising:
a container receiving region horizontally adjacent to the stack receiving region, wherein the handling member is vertically movable within the container receiving region and horizontally moveable between the container receiving region and the stack receiving region to extract the target container from the stack into the container receiving region and/or insert a free container from the container receiving region into the stack.

66. The stack processing apparatus of claim 65, comprising:
a container port region horizontally adjacent to the container receiving region, the container port region including a container port configured to receive a target container from the container receiving region and/or receive a free container to be moved into the container receiving region.

67. The stack processing apparatus of claim 66, wherein the container port region comprises:
a plurality of container ports arranged vertically or arranged in a horizontal plane about the container receiving region.

68. The stack processing apparatus of claim 66, wherein the handling member is horizontally movable between the container receiving region and the container port region and configured to allow the handling member to move the target container from the container receiving region to one or more of the container ports and/or to move a free container from one or more of the container ports to the container receiving region; and optionally:
wherein the container handling mechanism includes a plurality of vertically arranged handling members, each handling member being vertically moveable within the container receiving region independently of the other handling members, and wherein at least one handling member of the plurality of handling members is horizontally moveable between the container receiving region and container port region.

69. The stack processing apparatus of claim 67, wherein at least one of the container ports is an out-feed port configured to receive the target container from the container receiving region, and at least one of the container ports is an in-feed port configured to receive a free container to be moved to the container receiving region.

70. The stack processing apparatus of claim 69, wherein the out-feed port is connected to the in-feed port by a container path external to the container receiving region, along which the target container will travel from the out-feed port to the in-feed port; and optionally:
wherein the out-feed port and the in-feed port are vertically arranged and the container path includes vertical transportation means configured to move a container from a height of the out-feed port to a height of the in-feed port.

71. The stack processing apparatus of claim 66, wherein the container receiving region comprises:
a container receiving surface configured to receive the target container from the handling member and deliver the target container to any one of the container ports and/or receive a free container from any one of the container ports for insertion into the stack by the handling member; and optionally:
wherein the container receiving surface is vertically moveable within the container receiving region independently of the handling member.

72. The stack processing apparatus of claim 66, comprising:
a container processing region configured to receive the target container from the container port and configured to allow items to be taken out of or placed into the container; and optionally:
including a buffer region for temporarily storing one or more containers without blocking the container processing region.

73. The stack processing apparatus of claim 59, wherein the stack separating mechanism comprises: a supporting member configured to releasably engage a container in the stack, the supporting member being vertically moveable within the stack receiving region and configured to engage a container in the lower sub-stack while the separating member is separating the stack and/or while the handling member is extracting the target container.

74. The stack processing apparatus of claim 59, comprising:
a control system including a container recognition system configured to determine a vertical position of one or more containers in the stack, wherein the control system is configured to vertically move the separating member and/or handling member based on determined vertical positions.

75. The stack processing apparatus of claim 59, wherein the stack separating mechanism comprises:
a plurality of vertically arranged separating members, wherein the vertically arranged separating members are vertically moveable within the stack receiving region independently of each other and configured to allow the vertically arranged separating members to move to and engage a plurality of containers in the stack and vertically lift the engaged containers relative to each other to separate the stack into more than two sub-stacks; and optionally:
wherein the stack receiving region is configured to receive a predetermined maximum number of vertically stacked containers and a number of vertically arranged separating members corresponds at least to the predetermined maximum number of vertically stacked containers configured and arranged to allow the vertically arranged separating members to move to and engage every container in the stack and vertically lift every container relative to each other to separate the stack in a plurality of sub-stacks, each sub-stack containing only one container.

76. A stack processing apparatus of claim 59 in a stack processing station comprising:
a first stack processing apparatus according to claim 59; and
a second stack processing apparatus according to claim 59;
wherein the first stack processing apparatus is connected to the second apparatus to allow a target container extracted from a stack in the first stack processing apparatus to travel to the second stack processing apparatus for insertion into a stack in the second stack processing apparatus.

77. A stack processing station of claim 76 is a stack processing system, the system comprising:
one or more vertical stacks of containers; and
one or more stack processing apparatuses or one or more stack processing stations.

78. A method of processing a vertical stack of containers using a stack processing apparatus which includes a stack receiving section, a stack separating mechanism, and a container handling mechanism, the method comprising:
(i) vertically lifting a container within the vertical stack to separate the stack into an upper sub-stack and a lower sub-stack;
(ii) horizontally extracting a target container at a top of the lower sub-stack out of the stack and/or horizontally inserting a free container between the upper sub-stack and the lower sub-stack; and
(iii) lowering the upper sub-stack onto the lower sub-stack to reform the stack.

79. The method of claim 78, comprising:
after extracting the target container in step (ii), placing an item into and/or removing an item from the target container; and
inserting the target container back into the stack or a different stack.
